(19) United States
(12) Patent Application Publication
(10) Pub. No.: US 2026/0213835 A1
(43) Pub. Date: Jul. 23, 2026

(54) HANDLING A STORE AND FORWARD SATELLITE OPERATION FOR SATELLITE COMMUNICATION

(71) Applicant: Samsung Electronics Co., Ltd., Suwon-si (KR)

(72) Inventors: Aman AGARWAL, Bangalore (IN); Dinesh Rooparam CHOUDHARY, Bangalore (IN); Lalith KUMAR, Bangalore (IN); Sidhant JAIN, Bangalore (IN)

(21) Appl. No.: 19/572,440

(22) Filed: Mar. 19, 2026

Related U.S. Application Data
(63) Continuation of application No. PCT/KR2024/014070, filed on Sep. 13, 2024.

(30) Foreign Application Priority Data
Sep. 20, 2023 (IN) 202341063298
Sep. 6, 2024 (IN) 2023 41063298

(51) Int. Cl. H04B 7/185; H04W 8/24

(52) U.S. Cl. CPC H04B 7/1853; H04W 8/24

(57) ABSTRACT

A method for handling a store and forward (S&F) satellite operation for satellite communication is provided. The method includes determining, by a network apparatus, whether the network apparatus is operating in a S&F satellite operation mode or not, and transmitting, by the network apparatus, at least one of a system information block (SIB) message or a non-access stratum (NAS) signaling message to a user equipment (UE) in accordance with a determination that the network apparatus is operating in the S&F satellite operation mode

### CROSS-REFERENCE TO RELATED APPLICATION(S)

This application is a continuation application, claiming priority under 35 U.S.C. § 365(c), of an International application No. PCT/KR2024/014070, filed on Sep. 13, 2024, which is based on and claims the benefit of an Indian Provisional patent application number 202341063298, filed on Sep. 20, 2023, in the Indian Intellectual Property Office, and of an Indian Complete patent application number 202341063298, filed on Sep. 6, 2024, in the Indian Intellectual Property Office, the disclosure of each of which is incorporated by reference herein in its entirety.

### BACKGROUND

### 1. Field

The disclosure relates to the field of satellite communication. More particularly, the disclosure relates to a system and method for handling a store and forward (S&F) satellite operation for satellite communication.

### 2. Description of Related Art

A 5^{th} generation (5G) system with satellite access must provide service continuity across new radio (NR) terrestrial access networks and NR satellite access networks controlled by the same operator or two distinct operators with an agreement. The non-terrestrial network (NTN) and terrestrial network (TN) might operate in two distinct frequency bands (e.g., frequency range (FR1) FR1 versus FR2) or in the same frequency band (e.g., FR1 or FR2). The satellite system or satellite access described in this embodiment is applicable to both 5G and 4^{th} generation (4G) systems, as well as any radio access technology (RAT) with satellite access. The terms satellite 3^{rd} p3GPP access, satellite access, satellite access network, NR satellite access network, satellite next generation (NG)-radio access network (RAN) access technology and NR satellite access have been interchangeably used and have the same meaning. The store and forward (S&F) satellite operation in a 5G system with satellite access is intended to provide some level of communication service to user equipment (UEs) under satellite coverage with intermittent/temporary satellite connectivity (e.g., when the satellite is not connected via a feeder link or via inter-satellite link (ISL) to the ground network) for delay-tolerant communication service.

When a feeder link is not available for the serving satellite at the current UE location, the 5G or 4G system with satellite access may support the store and forward mechanism (also known as the S/F operating mode or S&F mode or S&F Satellite mode or S&F Satellite operation). When a feeder link is unavailable, there may be a maximum quantity of data storage (for example, S&F data storage quota) and a data storage validity duration (for example, S&F data retention period) associated with the data saved by the satellite, for any/all UE(s) or per UE. However, it is possible that some UE(s) do not enable or do not support delay-tolerant communication. Similarly, a 5G/4G system with satellite(s) may or may not enable or support delay-tolerant communication or the store and forward technique. Thus, it is unclear how the capacity of the UE(s) or the 5G/4G system with satellite(s) is determined.

Furthermore, the UE(s) may be unaware if the 5G/4G system with satellite access supports the S&F mechanism or not, and there is no defined manner for the UE or the Satellite to communicate their support for the S&F operation/mechanism with one another. Furthermore, how the maximum quantity of data storage and data storage validity duration for the S&F mechanism are configured in the UE is unclear and must be explained. Furthermore, there is no specified method for the UE or network to communicate or set the S&F parameters/configuration or their values (for example, S&F data storage quota, S&F data retention duration, validity timer, S&F Data forwarding priority etc.) with one another.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and system for handling a store and forward (S&F) satellite operation for satellite communication.

Another aspect of the disclosure is to enable the network to indicate to the UE whether S&F satellite operation is available or not. The network provides the indication using system information block (SIB) broadcast messages or via non access stratum (NAS) signaling (e.g. using Attach Accept, Tracking Area Update (TAU) Accept, Registration Accept and the like).

Another aspect of the disclosure is to enable the network to indicate to the UE one or more services/applications (for example, short message service (SMS), voice message, etc.) that are supported in S&F mode.

Another aspect of the disclosure is to enable the UE to indicate its S&F capability and S&F parameters (for example, data storage quota, data retention period, etc.) to the network via NAS signaling.

Another aspect of the disclosure is to enable the network to indicate the determined S&F capability and the S&F parameters (for example, data storage quota, data retention period, data forwarding priority etc.) to the UE via NAS signaling.

Another aspect of the disclosure is to enable the UE and the network to negotiate the S&F capability during an attach or a registration procedure.

Another aspect of the disclosure is to enable the network to switch between S&F Mode and normal mode based on its location or feeder link availability status, where the S&F mode is defined per a location/area basis.

Another aspect of the disclosure is to enable the UE to determine whether it can operate in S&F mode in the current network or not based on one or more policies associated with the UE.

Another aspect of the disclosure is to allow the UE and the network to store the S&F capability as a part of a UE subscription information.

Another aspect of the disclosure is to enable the UE and the network to determine the S&F capability/parameters based on a satellite coverage availability information.

Another aspect of the disclosure is to enable the network to transmit the stored data, signaling or any S&F capability and S&F parameters to the ground network or to the UE based on a data forward priority.

Another aspect of the disclosure is to enable the network to discard the stored S&F capability and S&F parameters when it is determined that a S&F data storage quota of the UE has been exhausted.

Additional aspects will be set forth in part in the description which follows and, in part, will be apparent from the description, or may be learned by practice of the presented embodiments.

In accordance with an aspect of the disclosure, a method for handling a store and forward (S&F) satellite operation for satellite communication is provided. The method includes determining, by a network apparatus, whether the network apparatus is operating in a S&F satellite operation mode or not, and transmitting, by the network apparatus, at least one of a system information broadcasting system information block (SIB) message or a Master Information Broadcast Master Information Block (MIB) message to a user equipment (UE) when the network apparatus is operating in the S&F satellite operation mode.

In an embodiment, the network apparatus is at least one of an evolved-NodeB (e-nodeB or eNB), an evolved universal terrestrial radio access network (E-UTRAN), an E-UTRAN cell, a mobility management entity (MME), a Serving Gateway (SGW), a Packet Data Network Gateway (PDN Gateway or PGW), a home subscriber server (HSS), a next generation NodeB (g-nodeB or gNB), a next generation radio access network (NG-RAN), an NG-RAN cell, an access and mobility management function (AMF), an unified data management entity (UDM), an Authentication Server Function (AUSF), a Session Management Function (SMF), an User Plane Function (UPF), a network entity, and a network function.

In an embodiment, the network apparatus is present either on-board the satellite, or on the ground, or is present both on-board the satellite and on the ground.

In an embodiment, the SIB message includes at least one of a SIB31 message, a SIB32 message, a SIB19 message, an existing SIB message, and a new SIB message.

In an embodiment, the network apparatus can transmit a MIB message to the UE when the network apparatus is operating in the S&F satellite operation mode.

In an embodiment, the NAS signaling message transmitted by the network apparatus to the UE includes at least one of an attach accept message, an attach reject message, a tracking area update (TAU) accept message, a TAU reject message, a service accept message, a service reject message, a registration accept message, a registration reject message, an authentication result message, an authentication reject message, a detach accept message, a deregistration accept message, a UE configuration update command (UCU) message, a UE parameters update command (UPU) message, a UE capability enquiry message, packet data unit (PDU) session establishment accept, PDU session establishment reject, PDN Connectivity Accept, PDN Connectivity Reject, an existing NAS signaling message, and a new NAS signaling message.

In an embodiment, the SIB message, the MIB message and the NAS signaling message include at least one of the support of the S&F satellite operation mode, the configuration of the S&F satellite operation mode, and the plurality of parameters of the S&F satellite operation mode.

In an embodiment, the support of the S&F satellite operation mode is indicated by at least one of an existing information element (IE), a new IE, an existing capability, a new capability, an existing parameter, a new parameter, a UE capability, a UE core network capability, a UE network capability, a feature flag, a support flag, a S&F support capability, a S&F support flag, a S&F feature support flag, a S&F indication, and a S&F flag.

In an embodiment, the plurality of parameters of the S&F satellite operation mode includes at least one of a S&F support capability, a S&F data storage quota, a S&F data retention period and a S&F data forwarding priority.,

In an embodiment, the plurality of parameters of the S&F satellite operation mode is determined based on a satellite coverage availability information.

In an embodiment, the method includes determining the S&F support capability of the network apparatus based on a plurality of factors. Further, the method includes handling the S&F satellite operation mode based on the plurality of factors. In addition, the method includes performing a negotiation with the UE based on the plurality of factors. The negotiation enables the UE and the network apparatus to negotiate at least one of a capability of the S&F satellite operation, a configuration of the S&F satellite operation, and the plurality of parameters of the S&F satellite operation during the NAS signaling.

In an embodiment, the plurality of factors include at least one of a location, an area, a time-slot, a time period, a time-zone, an application, a service, a feeder link availability status, a satellite coverage availability information, a UE subscription, a policy, a regulatory requirement, an operator policy, a UE type, a UE priority, a data type, a data priority, a network type, and a UE usage setting.

In an embodiment, the method includes detecting whether a feeder link is not available when the network apparatus supports the S&F satellite operation mode. In addition, the method includes transmitting at least one of the SIB message, the MIB message and the NAS signaling message to the UE indicating that the S&F satellite operation is being applied (e.g. the S&F mode is applied or Network is supporting S&F mode) when the feeder link is not available.

In an embodiment, the method includes determining whether the network apparatus has limited storage space. In addition, the method includes allocating one or more S&F parameters to the UE if the network apparatus has limited storage space.

In an embodiment, handling, by the network apparatus, at least one of the support of the S&F satellite operation mode, the configuration of the S&F satellite operation mode, and the plurality of parameters of the S&F satellite operation mode includes determining one or more services that are supported and one or more services that are restricted by the UE and the network apparatus when the network apparatus operates in the S&F satellite operation mode.

In an embodiment, the method includes determining one or more geographical areas where the network apparatus is connected to a ground network via a feeder link. Further, the method includes performing one of retaining (e.g. keeping or setting) the network apparatus in the S&F satellite operation mode when the network apparatus cannot connect to the ground network via the feeder link (e.g. when feeder link is not available), or switching (e.g. setting) the network apparatus to the normal mode or default mode (e.g. non-Store and Forward mode or a mode not supporting S&F), and retaining (or setting or keeping) the network apparatus in the S&F satellite operation mode when the network apparatus is connected to the ground network via the feeder link.

In an embodiment, normal mode or default mode refers to a mode where the network apparatus is operating in a mode without Store and Forward capability. It refers to a mode where the network apparatus is operating in full capability mode and doesn't need any limited capability (e.g. S&F mode) and has a feeder link available with the ground network or is connected to the ground network in any available direction connection.

In an embodiment, the method includes handling, by the network apparatus, at least one of the support of the S&F satellite operation mode, the configuration of the S&F satellite operation mode, and the plurality of parameters of the S&F satellite operation mode includes determining a data forward priority based on at least one of a priority of the network apparatus, a priority of the data, and a priority of the UE. In an embodiment, the data forward priority is based on least one of a type of the data and a type of the UE. Further, the method includes performing one of transmitting a stored data and/or signaling based on the data forward priority to the ground network, and transmitting the stored data and/or signaling based on the data forward priority to the UE.

In an embodiment, handling, by the network apparatus, at least one of the support of the S&F satellite operation mode, the configuration of the S&F satellite operation mode, and the plurality of parameters of the S&F satellite operation mode includes determining whether a feeder link is not available. Further, the method includes determining whether a S&F data storage quota of the UE has been exhausted. Further, the method includes discarding the data of the UE when the S&F data storage quota of the UE is exhausted. In addition, the method includes transmitting an indication message to the UE. The indication message indicates that the stored data has been discarded when the S&F data storage quota of the UE is exhausted.

In an embodiment, the method includes determining whether the UE has subscribed for a S&F capability by using UE subscription information. The UE subscription information includes at least one of a S&F data storage quota of the UE, a S&F data retention period of the UE, a S&F data forwarding priority of the UE and a S&F support capability of the UE. Further, the method includes storing at least one of the support of the S&F satellite operation mode, the configuration of the S&F satellite operation mode, and the plurality of parameters of the S&F satellite operation mode in the UE subscription information in at least one of a home subscriber server (HSS) and an unified data management entity (UDM). In addition, the method includes retrieving the UE subscription information from at least one of the HSS and the UDM.

In accordance with another aspect of the disclosure, a method for handling a store and forward (S&F) satellite operation for satellite communication is provided. The method includes determining, by a user equipment (UE), whether the UE is in a satellite coverage with a network apparatus and whether the UE supports a S&F satellite operation mode or not, and in accordance with a determination that the UE is in the satellite coverage and supports the S&F satellite operation mode, receiving, from the network apparatus, a system information broadcasting system information block (SIB) message or a non-access stratum (NAS) signaling message from the network apparatus operating in the S&F satellite operation mode.

In an embodiment, the method includes determining whether the UE has subscribed for a S&F capability by using UE subscription information for a S&F capability. The UE subscription information includes at least one of a S&F data storage quota of the UE, a S&F data retention period of the UE, a S&F data forwarding priority of the UE and a S&F support capability of the UE.

In an embodiment, the first NAS signaling message transmitted by the UE to the network apparatus includes at least one of an Attach Request message, a TAU Request message, a Service Request message, a Registration Request message, an Authentication Request message, a Detach Request message, a Deregistration Request message, an UE capability information message, PDU Session establishment request, PDN Connectivity request, an existing NAS signaling message and a new NAS signaling message.

In an embodiment, the first NAS signaling message includes at least one of a S&F feature supported flag signaling an ability of the UE to handle S&F operations, an expected S&F data storage quota of the UE, a S&F data retention period and a S&F data forwarding priority.

In an embodiment, at least one of the NAS signaling message from the network apparatus and the second NAS signaling message from the network apparatus includes at least one of an attach accept message, an attach reject message, a tracking area update (TAU) accept message, a TAU reject message, a service accept message, a service reject message, a registration accept message, a registration reject message, an authentication result message, an authentication reject message, a detach accept message, a deregistration accept message, PDU session establishment accept, PDU session establishment reject, PDN Connectivity Accept, PDN Connectivity Reject, a UE configuration update command (UCU) message, a UE parameters update command (UPU) message, a UE capability enquiry message, an existing NAS signaling message, and a new NAS signaling message.

In an embodiment, at least one of the NAS signaling message from the network apparatus and the second NAS signaling message includes at least one of a S&F support capability of the network apparatus, a S&F data retention period of the network apparatus, and a determined S&F data storage quote of the network apparatus.

In an embodiment, the S&F data retention period is determined based on a satellite coverage availability information.

In an embodiment, the method includes determining a S&F support capability of the UE based on the first NAS signaling message and a plurality of factors. Further, the method includes handling the network apparatus operated in the S&F satellite operation mode based on the plurality of factors. In addition, the method includes performing a negotiation with the network apparatus based on the plurality of factors. The negotiation enables the UE and the network apparatus to negotiate a capability of the S&F satellite operation during the NAS signaling

In an embodiment, the plurality of factors include at least one of a location, an area, a time-slot, a time period, a time-zone, an application, a service, a feeder link availability status, a satellite coverage availability information, a UE subscription, a policy, a regulatory requirement, an operator policy, a UE type, a UE priority, a data type, a data priority, a network type, and a UE usage setting.

In an embodiment, the method includes determining whether to access the network apparatus that supports the S&F satellite operation mode or access one or more other networks that do not support the S&F satellite operation mode, based on one or more policies associated with the UE.

In accordance with another aspect of the disclosure, a network apparatus for handling a store and forward (S&F) satellite operation for satellite communication is provided. The network apparatus includes at least one processor comprising processing circuitry, and memory storing instructions that, wherein the instructions, when executed by the at least one processor individually or collectively, cause the network apparatus to determine whether the network apparatus is operating in a S&F satellite operation mode or not, and transmit at least one of a system information block (SIB) message or a non-access stratum (NAS) signaling message to a user equipment (UE) in accordance with a determination that the network apparatus is operating in the S&F satellite operation mode.

In an embodiment, the network apparatus is at least one of an evolved-NodeB (e-nodeB or eNB), an evolved universal terrestrial radio access network (E-UTRAN), an E-UTRAN cell, a mobility management entity (MME), a Serving Gateway (SGW), a Packet Data Network Gateway (PDN Gateway or PGW), a home subscriber server (HSS), a next generation NodeB (g-nodeB or gNB), a next generation radio access network (NG-RAN), an NG-RAN cell, an access and mobility management function (AMF), an unified data management entity (UDM), an Authentication Server Function (AUSF), a Session Management Function (SMF), an User Plane Function (UPF), a network entity, and a network function.

In an embodiment, the network apparatus is present either on-board the satellite and/or on the ground.

In an embodiment, the SIB message includes at least one of a SIB31 message, a SIB32 message, a SIB19 message, an existing SIB message, and a new SIB message.

In an embodiment, the NAS signaling message transmitted by the network apparatus to the UE include at least one of an attach accept message, an attach reject message, a tracking area update (TAU) accept message, a TAU reject message, a service accept message, a service reject message, a registration accept message, a registration reject message, an authentication result message, an authentication reject message, a detach accept message, a deregistration accept message, a UE configuration update command (UCU) message, a UE parameters update command (UPU) message, a UE capability enquiry message, PDU session establishment accept, PDU session establishment reject, PDN Connectivity Accept, PDN Connectivity Reject, an existing NAS signaling message, and a new NAS signaling message.

In an embodiment, the SIB message, the MIB message and the NAS signaling message include at least one of the support of the S&F satellite operation mode, the configuration of the S&F satellite operation mode, and the plurality of parameters of the S&F satellite operation mode.

In an embodiment, the SIB message and the MIB message are illustrated as examples. It can be any broadcast message from the network apparatus.

In an embodiment, the support of the S&F satellite operation mode is indicated by at least one of an existing information element (IE), a new IE, an existing capability, a new capability, an existing parameter, a new parameter, a UE capability, a UE core network capability, a UE network capability, a feature flag, a support flag, a S&F support capability, a S&F support flag, a S&F feature support flag, a S&F indication, and a S&F flag.

In an embodiment, the plurality of parameters of the S&F satellite operation mode includes at least one of a S&F support capability, a S&F data storage quota, a S&F data retention period and a S&F data forwarding priority.

In an embodiment, the plurality of parameters of the S&F satellite operation mode (e.g. S&F Data quota, S&F Data Retention period etc.) is determined based on a satellite coverage availability information.

In an embodiment, the first S&F controller determines the S&F support capability of the network apparatus based on a plurality of factors. Further, first S&F controller handles the S&F satellite operation mode based on the plurality of factors. In addition, the first S&F controller performs a negotiation with the UE based on the plurality of factors. The negotiation enables the UE and the network apparatus to negotiate at least one of a capability of the S&F satellite operation, a configuration of the S&F satellite operation, and the plurality of parameters of the S&F satellite operation during the NAS signaling.

In an embodiment, the plurality of factors include at least one of a location, an area, a time-slot, a time period, a time-zone, an application, a service, a feeder link availability status, a satellite coverage availability information, a UE subscription, a policy, a regulatory requirement, an operator policy, a UE type, a UE priority, a data type, a data priority, a network type, and a UE usage setting.

In an embodiment, the first S&F controller detects whether a feeder link is not available when the network apparatus supports the S&F satellite operation mode. In addition, the first S&F controller transmits at least one of the SIB message and the NAS signaling message to the UE indicating that the S&F satellite operation is being applied when the feeder link is not available.

In an embodiment, the first S&F controller determines whether the network apparatus currently has limited storage space. In addition, the first S&F controller allocates one or more S&F parameters to the UE if the network apparatus has limited storage space.

In an embodiment, the first S&F controller determines one or more services that are supported and one or more services that are restricted by the UE and the network apparatus when the network apparatus operates in the S&F satellite operation mode.

In an embodiment, the first S&F controller determines one or more geographical areas where the network apparatus is connected to a ground network via a feeder link. Further, the first S&F controller performs one of retains the network apparatus in the S&F satellite operation mode when the network apparatus cannot connect to the ground network via the feeder link, or switches the network apparatus to the normal mode or default mode, and retains the network apparatus in the S&F satellite operation mode when the network apparatus is connected to the ground network via the feeder link.

In an embodiment, the first S&F controller determines a data forward priority based on at least one of a priority of the network apparatus, a priority of the data, a priority of the UE, a type of the data and a type of the UE. Further, the first S&F controller performs at least one of transmits a stored data based on the data forward priority to the ground network, and transmits the stored data based on the data forward priority to the UE.

In an embodiment, the first S&F controller determines whether a feeder link is not available. Further, the first S&F controller determines whether a S&F data storage quota of the UE has been exhausted. Further, the first S&F controller discards the data of the UE when the S&F data storage quota of the UE is exhausted. In addition, the first S&F controller transmits an indication message to the UE. The indication message indicates that the stored data has been discarded when the S&F data storage quota of the UE is exhausted.

In an embodiment, the first S&F controller determines whether the UE has subscribed for a S&F capability by using UE subscription information. The UE subscription information includes at least one of a S&F data storage quota of the UE, a S&F data retention period of the UE, a S&F data forwarding priority of the UE, and a S&F support capability of the UE. Further, the first S&F controller stores at least one of the support of the S&F satellite operation mode, the configuration of the S&F satellite operation mode, and the plurality of parameters of the S&F satellite operation mode in the UE subscription information in at least one of a home subscriber server (HSS), a unified data management entity (UDM) or in any network function/entity. In addition, the first S&F controller retrieves the UE subscription information from at least one of a home subscriber server (HSS), a UDM or any network function/entity.

In accordance with another aspect of the disclosure, a user equipment (UE) for handling a store and forward (S&F) satellite operation for satellite communication is provided. The UE includes at least one processor comprising processing circuitry, and memory storing instructions that, wherein the instructions, when executed by the at least one processor individually or collectively, cause the UE to determine whether the UE is in a satellite coverage with a network apparatus and whether the UE supports a S&F satellite operation mode or not, and in accordance with a determination that the UE is in the satellite coverage and supports the S&F satellite operation mode, receive, from a network apparatus, a system information block (SIB) message or a non-access stratum (NAS) signaling message from the network apparatus operating in the S&F satellite operation mode.

In an embodiment, the SIB message, the MIB message and the NAS signaling message include at least one of the support of the S&F satellite operation mode, the configuration of the S&F satellite operation mode, and the plurality of parameters of the S&F satellite operation mode.

In an embodiment, the second S&F controller determines whether the UE has subscribed for a S&F capability by using UE subscription information for a S&F capability. The UE subscription information includes at least one of a S&F data storage quota of the UE, a S&F data retention period of the UE, a S&F data forwarding priority of the UE, and a S&F support capability of the UE.

In an embodiment, the first NAS signaling message transmitted by the UE to the network apparatus includes at least one of an Attach Request message, a TAU Request message, a Service Request message, a Registration Request message, an Authentication Request message, a Detach Request message, a Deregistration Request message, an UE capability information message, PDU Session establishment request, PDN Connectivity request, an existing NAS signaling message and a new NAS signaling message.

In an embodiment, the first NAS signaling message includes a S&F feature supported flag signaling an ability of the UE to handle S&F operations, an expected S&F data storage quota of the UE, a S&F data retention period and a S&F data forwarding priority.

In an embodiment, at least one of the NAS signaling message from the network apparatus (202) and the second NAS signaling message from the network apparatus (202) includes at least one of an attach accept message, an attach reject message, a tracking area update (TAU) accept message, a TAU reject message, a service accept message, a service reject message, a registration accept message, a registration reject message, an authentication result message, an authentication reject message, a detach accept message, a deregistration accept message, a UE configuration update command (UCU) message, a UE parameters update command (UPU) message, a UE capability enquiry message, PDU session establishment accept, PDU session establishment reject, PDN Connectivity Accept, PDN Connectivity Reject, an existing NAS signaling message, and a new NAS signaling message.

In an embodiment, at least one of the NAS signaling message from the network apparatus and the second NAS signaling message includes at least one of a S&F support capability of the network apparatus, a S&F data retention period of the network apparatus, and a determined S&F data storage quote of the network apparatus.

In an embodiment, the S&F data retention period is determined based on a satellite coverage availability information.

In an embodiment, the second S&F controller determines a S&F support capability of the UE based on the first NAS signaling message and a plurality of factors. Further, the second S&F controller handles the network apparatus operated in the S&F satellite operation mode based on the plurality of factors. In addition, the second S&F controller performs a negotiation with the network apparatus based on the plurality of factors. The negotiation enables the UE and the network apparatus to negotiate a capability of the S&F satellite operation during the NAS signaling

In an embodiment, the plurality of factors include at least one of a location, an area, a time-slot, a time period, a time-zone, an application, a service, a feeder link availability status, a satellite coverage availability information, a UE subscription, a policy, a regulatory requirement, an operator policy, a UE type, a UE priority, a data type, a data priority, a network type, and a UE usage setting.

In an embodiment, the second S&F controller determines whether to access the network apparatus that supports the S&F satellite operation mode or access one or more other networks that do not support the S&F satellite operation mode, based on one or more policies associated with the UE.

In accordance with another aspect of the disclosure, one or more non-transitory computer-readable storage media storing one or more computer programs including computer-executable instructions that, when executed by one or more processors of an network apparatus individually or collectively, cause the network apparatus to perform operations are provided. The operations include determining, by a network apparatus, whether the network apparatus is operating in a S&F satellite operation mode or not, and transmitting, by the network apparatus, at least one of a system information block (SIB) message or a non-access stratum (NAS) signaling message to a user equipment (UE) in accordance with a determination that the network apparatus is operating in the S&F satellite operation mode.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic diagram that illustrates a normal/default satellite operation mode according to an embodiment of the disclosure;

FIG. 2 is a schematic diagram that illustrates a S&F satellite operation mode according to an embodiment of the disclosure;

FIG. 3 is a sequence diagram that illustrates determination of S&F support and S&F parameters according to an embodiment of the disclosure;

FIG. 4 is a sequence diagram that illustrates switching between normal mode to S&F mode based on location according to an embodiment of the disclosure;

FIG. 5 is a sequence diagram that illustrates indication of supported services in S&F mode according to an embodiment of the disclosure;

FIGS. 6A and 6B are block diagrams that illustrate handling of a S&F data retention period according to various embodiments of the disclosure;

FIGS. 7A, 7B, and 7C are block diagrams that illustrate handling of a S&F data storage quota according to various embodiments of the disclosure;

FIG. 8 is a block diagram that illustrates a schematic of a network apparatus implemented to carry out the disclosed subject matter according to an embodiment of the disclosure;

FIG. 9 is a block diagram that illustrates a schematic of a UE implemented to carry out the disclosed subject matter according to an embodiment of the disclosure;

FIG. 10 is a sequence diagram that illustrates handling the S&F satellite operation for satellite communication according to an embodiment of the disclosure;

FIG. 11 is a sequence diagram that illustrates switching between normal mode to S&F mode based on location according to an embodiment of the disclosure;

FIG. 12 is a sequence diagram that illustrates indication of supported services in S&F mode according to an embodiment of the disclosure;

FIGS. 13A, 13B, 13C, and 13D are block diagrams that illustrate handling of the S&F data retention period according to various embodiments of the disclosure;

FIGS. 14A, 14B, and 14C are block diagrams that illustrate handling of the S&F data storage quota according to various embodiments of the disclosure;

FIGS. 15A and 15B are flowcharts that illustrate a method for handling a store and forward (S&F) satellite operation for satellite communication by the network apparatus according to various embodiments of the disclosure; and

FIG. 16 is a flowchart that illustrates a method for handling a store and forward (S&F) satellite operation for satellite communication by the UE according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As is traditional in the field, embodiments are described and illustrated in terms of blocks that carry out a described function or functions. These blocks, which referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and optionally be driven by firmware and software. The circuits, for example, be embodied in one or more semiconductor chips, or on substrate supports such as printed circuit boards and the like. The circuits constituting a block be implemented by dedicated hardware, or by a processor (e.g., one or more programmed microprocessors and associated circuitry), or by a combination of dedicated hardware to perform some functions of the block and a processor to perform other functions of the block. Each block of the embodiments be physically separated into two or more interacting and discrete blocks without departing from the scope of the proposed method. Likewise, the blocks of the embodiments be physically combined into more complex blocks without departing from the scope of the proposed method.

Although the terms first, second, etc. used herein to describe various elements, these elements are not be limited by these terms. These terms are generally used to distinguish one element from another.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

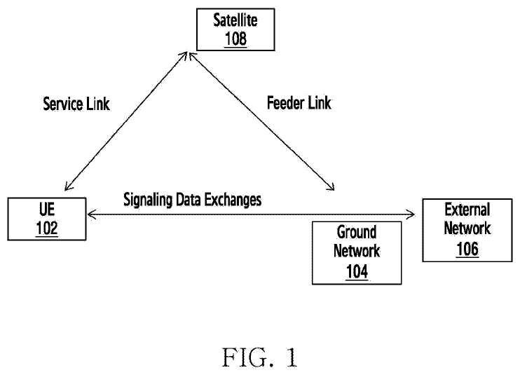

FIG. 1 is a schematic diagram that illustrates a normal/default satellite operation mode according to an embodiment of the disclosure.

Referring to FIG. 1, the schematic diagram includes a user equipment (UE) (102), a ground network (104), an external network (106), and a satellite (108). For example, the UE (102) may include an internet of things (IOT) device and the external network (106) may include an IOT application server. In the normal/default satellite operating mode, the signaling and data traffic exchange between the UE (102) with satellite access and the distant ground network (104) requires both the service link and feeder link connections to be operational at the same time. As a result, when the UE (102) interacts with the satellite (108) via the service link, a continuous end-to-end connection channel exists between the UE (102), the satellite (108), and the ground network (104). Refer to 3GPP TR 22.865 v19.2.0 annex A.

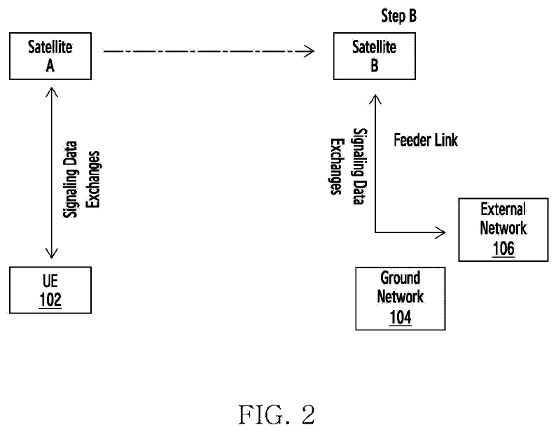

FIG. 2 is a schematic diagram that illustrates a S&F satellite operation mode according to an embodiment of the disclosure.

Referring to FIG. 2, the S&F satellite operating mode handles the end-to-end exchange of signaling/data traffic as a combination of two phases that are not contemporaneous in time in operations A and B. In operation A, the UE (102) and the satellite (108) exchange signals/data without the satellite (108) being linked to the ground network (104). For example, the satellite (108) can run the service link without an active feeder link connection. In operation B, connection between the satellite (108) and the ground network (104) is established, allowing communication between the two to occur. Thus, the satellite (108) moves from being connected to the UE (102) in operation A to being connected to the ground network (104) in operation B. Refer to 3GPP TR 22.865 v19.2.0 annex A.

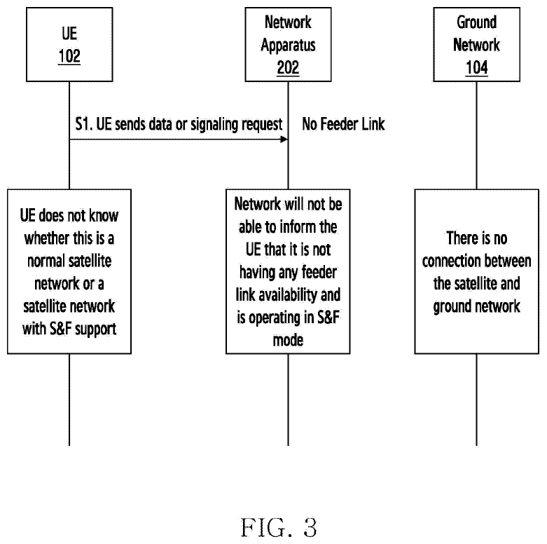

FIG. 3 is a sequence diagram that illustrates determination of S&F support and S&F parameters according to an embodiment of the disclosure.

Referring to FIG. 3, as shown in the sequence diagram, the UE (102), a network apparatus (202), and the ground network (104) are in communication with each other. At operation S1, the UE (102) sends a data or signaling request to the network apparatus (202). The network apparatus (202) and the ground network (104) cannot communicate since no feeder link is available. The UE (102) may not recognize whether this is a standard satellite network or one with S&F capability. The network apparatus (202) may be unable to notify the UE (102) that it does not have any feeder links available and is operating in S&F mode. According to current 3GPP standards, there is no way established for the UE (102) and/or network apparatus (202) to communicate S&F support with one another. Without S&F support negotiation, the UE (102) and the network apparatus (202) may not know if it is normal mode operation or S&F mode operation and several services/communication would be impacted.

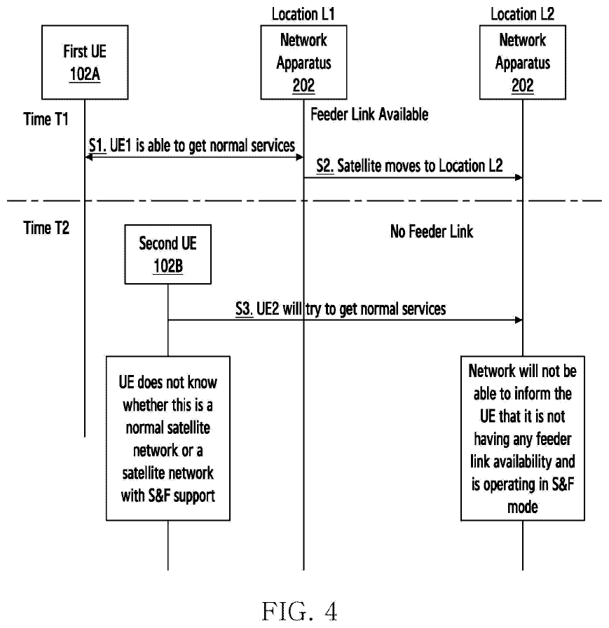

FIG. 4 is a sequence diagram that illustrates switching between normal mode to S&F mode based on location according to an embodiment of the disclosure.

Referring to FIG. 4, as shown in the sequence diagram, a first UE (102A) and a second UE (102B) are in communication with the network apparatus (202) at location L1 and location L2. At operation S1 (at time T1), the first UE (102A) is able to get normal services and informs the network apparatus (202) at location L1 regarding the same. At operation S2, the network apparatus (202) at location L1 moves to location L2. At operation S3 (at time T2), the second UE (102B) tries to get normal services with the network apparatus (202) at location L2.

However, there is currently no way for the network apparatus (202) to notify the second UE (102B), which may still be connected, or the first UE (102A), which wishes to connect to the network apparatus (202), that it is no longer operating in the normal mode and has switched to the S&F mode due to a change in location. The first UE (102A) and second UE (102B) may detect a normal network and connect with the network apparatus (202), but they may not get the needed services, resulting in a service outage.

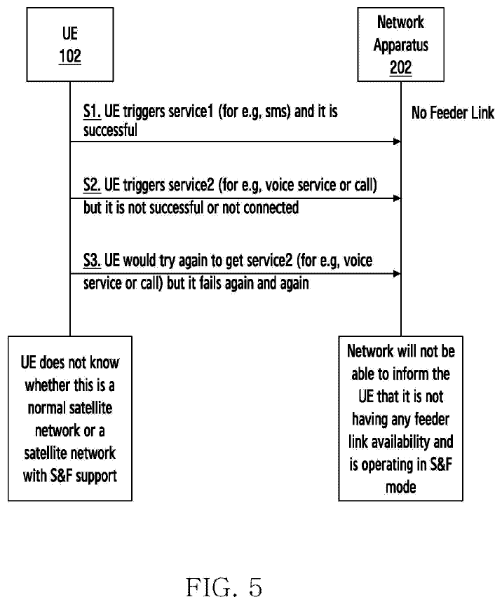

FIG. 5 is a sequence diagram that illustrates indication of supported services in S&F mode according to an embodiment of the disclosure.

Referring to FIG. 5, as shown in the sequence diagram, the UE (102) is in communication with the network apparatus (202). At operation S1, the UE (102) triggers a first service (for example, SMS) to the network apparatus (202) and is successful. At operation S2, the UE (102) triggers a second service (for example, voice service, call, etc.) to the network apparatus (202) and is not successful. At operation S3, the UE (102) attempts to get the service 2 (e.g. second service) again, but fails.

The UE (102) may be unaware of whether this is a standard satellite network or a satellite network with S&F support, as well as what services are and are not supported. The network apparatus (202) may be unable to notify the UE (102) that it does not have any feeder links available and is running in S&F mode, with only some services supported. There is currently no way for the network apparatus (202) to communicate to the UE (102) that it is functioning in the S&F mode and that only specific services (for example, SMS) are supported. The UE (102) may determine it to be a regular network and interact with the network apparatus (202) for all services, but may not get the intended services, resulting in network barring and other extreme measures. This may result in a negative or undesirable user experience.

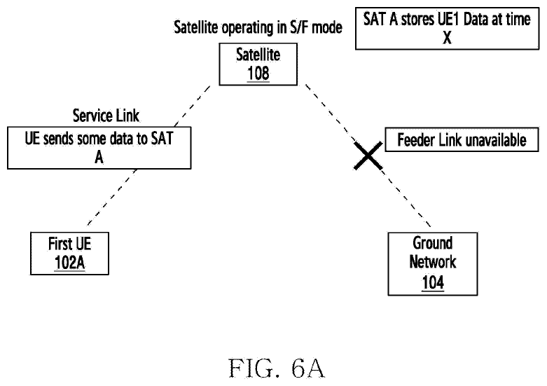

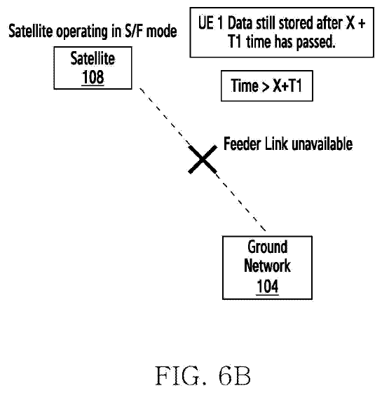

FIG. 6A and B are block diagrams that illustrate handling of a S&F data retention period according to various embodiments of the disclosure.

Referring to FIGS. 6A and 6B, as shown, the first UE (102A) is in communication with the satellite (108). The Satellite (108) doesn't have a feeder link available with the ground network (104). The first UE (102A) sends data to the satellite (108) at time X that needs to be delivered before X+T1 time. The satellite (108) does not have a feeder link and is operating in S/F mode at point L1. The first UE (102A) is covered by the satellite (108) and may be used in the S/F mechanism; no additional terrestrial network coverage is available. Satellite (108) stores the data for the first UE(102A) at time X. Time X+T1 has passed, and still the satellite (108) has stored the data of the first UE (102). Currently, there is no mechanism for the UE (102) to negotiate the period for which data can be stored in a satellite (108) server (data retention period), after which the stored data should be deleted by the satellite (108) if it is unable to deliver the data to the ground network (104).

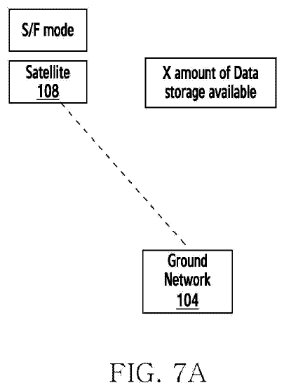

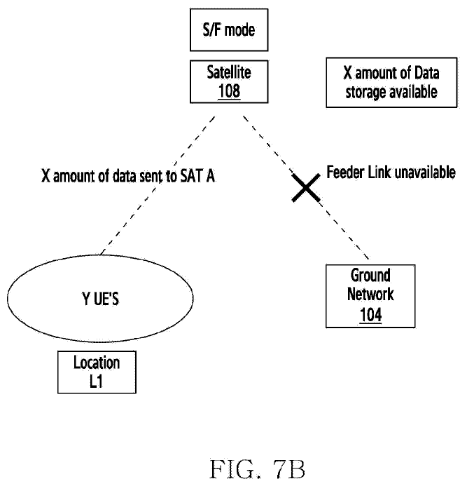

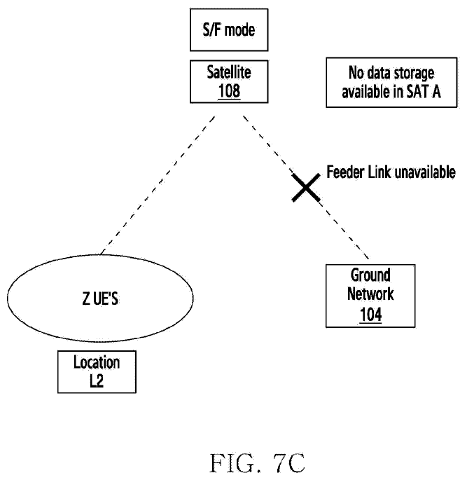

FIGS. 7A, 7B, and 7C are block diagrams that illustrate handling of a S&F data storage quota according to various embodiments of the disclosure.

Referring to FIGS. 7A to 7C, as shown, the ground network (104) and the satellite (108) are in communication with each other. The satellite (108) has no feeder link available and is operating in S/F mode at position L1, with X volume of data space available. At location L1, Y number of UEs are present, each of which supports the S/F mechanism and is permitted by the network apparatus (202) at L1. If all Y number of UEs consume X volume of data space available on the satellite (108) at location L1, then when the satellite (108) travels to another site L2 and continues to function in S/F mode, there will be no data space available on the satellite (108) to serve location L2. Furthermore, there is no method defined for the allocation of available data storage by the satellite (108) to the UE(s) of the current location L1 and future UEs accessible at location L2 prior to the availability of the feeder link connection.

The proposed solution describes a system and method for handling S&F satellite operations during satellite communication. The proposed solution allows the UE (102) and network apparatus (202) to detect and indicate their S&F capability/support, as well as the values/configuration of S&F parameters (such as S&F data storage quota, S&F data retention duration, validity timer, and so on). When a feeder link is not available, the UE (102) or the network apparatus (202) can negotiate S&F capability/support/parameters and interact with one another. Also, the UE (102) or the network apparatus (202) would be able to distinguish between regular/normal and S&F operating modes. Communication between the UE (102) and the network apparatus (202) is feasible because a protocol exists to handle such instances. The proposed solution would provide a better user experience for potential S&F services.

The Abbreviations used in this document:
3GPP Third Generation Partnership Project
4G-GUTI 4G-Globally Unique Temporary Identifier
5G-BRG 5G Broadband Residential Gateway
5GC 5G Core
5GCN5G Core Network
5G-CRG 5G Cable Residential Gateway
5G-GUTI 5G-Globally Unique Temporary Identifier
5GC 5G Mobility Management
5G-RG 5G Residential Gateway
5GC 5G System
5GSM5GS Session Management
5G-S-TMSI 5G S-Temporary Mobile Subscription Identifier
5G-TMSI 5G Temporary Mobile Subscription Identifier
5GC 5G QoS Identifier
ACS Auto-Configuration Server
AKA Authentication and Key Agreement
A-KID AKMA Key Identifier
AKMA Authentication and Key Management for Applications
AMBR Aggregate Maximum Bit Rate
AMF Access and Mobility Management Function
APN Access Point Name
ARP Allocation and Retention Policy
AS Access Stratum
A-TIDAKMA Temporary Identifier
ATSSS Access Traffic Steering, Switching and Splitting
AUSF Authentication Server Function
CAG Closed access group
CAG ID Closed Access Group Identifier
CHAP Challenge Handshake Authentication Protocol
CU Centralized Unit
DC Discontinuous Coverage
DisCo Discontinuous Coverage
DL Downlink
DND Do not Disturb
DRX Discontinuous Reception
DU Distributed Unit
eDRX Extended Discontinuous Reception
EHPLMN Equivalent Home Public Land Mobile Network
EMM EUTRA Mobility Management
eNB Evolved Node-B
eNPN Enhanced Non-Public Networks
EPC Evolved Packet Core
EPLMN Equivalent Public Land Mobile Network
EPS Evolved Packet System
eSIM embedded Subscriber Identity Module
E-UTRA Evolved Universal Mobile Telecommunication Access
EUTRAN Evolved Universal Mobile Telecommunication Access Network
FPLMN Forbidden Public Land Mobile Network
FR Frequency Range
GEO Geostationary Orbit
GERAN GSM Edge Radio Access Network
GERAN EC-GSM-IoT GSM Edge Radio Access Network Extended Coverage-GSM-Internet of Things
gNB Next generation Node-B
gNB-CU Next generation Node-B Control Unit
gNB-DU Next generation Node-B Distributive Unit
GPRS General Packet Radio Service
GPS Global Positioning System
GSM Global System for Mobile Communication
HPLMN Home Public Land Mobile Network
IAB Integrated access and backhaul
IAB-UE The part of the IAB node that supports the Uu interface towards the IAB-donor or another parent IAB-node (and thus manages the backhaul connectivity with either PLMN or SNPN it is registered with) is referred to as an IAB-UE.
LADN Local Area Data Network
LCS Location services
LEO Low Earth Orbit
MBSR Mobile Base Station Relay
MCC Mobile Country Code
MCS Mission Critical Service
ME Mobile Equipment
MEC Multi-Access Edge Computing
MEO Medium Earth Orbit
MICO Mobile Initiated Communication Only
MINT Minimization of service interruption
MME Mobility Management Entity
MNC Mobile Network Code
MPS Multimedia Priority Service
MS Mobile Station. The present document makes no distinction between MS and UE.
NAS Non-Access Stratum
NB-S1 Mode Narrow Band with S1 Interface
NGAP Next Generation Application Protocol
NG-RAN Next Generation Radio Access Network
NPN Non-Public Networks
NR New Radio
NTN Non Terrestrial Networks
NW Network
OOS Out of Service
OS Upgrade Operating System Upgrade
PDN Packet Data Network
PDU Packet Data Unit
PLMN ID Public Land Mobile Network Identity
PSM Power Saving Mode
QoS Quality Of Service
RAT Radio Access Technology
RPLMN Registered Public Land Mobile Network
RRC Radio Resource Control
RU Registration Update
SAT Satellite
Satellite: an artificial body placed in orbit round the earth or moon or another planet in order to collect information or for communication.
Satellite Constellation: Group of satellites, placed in orbit round the earth or moon or another planet in order to collect information or for communication.
Service User: An individual who has received a priority level assignment from a regional/national authority (i.e., an agency authorised to issue priority assignments) and has a subscription to a mobile network operator
SIM Subscriber Identity Module
SNPN Standalone Non-Public Networks
SUCI Subscription Concealed Identifier
SW Software
TAC Tracking Area Code
TAI Tracking Area Identity
TAU Tracking Area Update
TER Terrestrial
TN Terrestrial Networks
UCU UE Configuration Update
UDM Unified Data Management Function
UE User Equipment
UL Uplink
ULI User Location Information
UPU UE Parameters Update
USIM Universal Subscriber Identification Module
Uu The radio interface between the UE and the Node B
VMR Vehicle Mounted Relay
VPLMN Visited Public Land Mobile Network
WB-S1 Mode Wide Band with S1 Interface

In an embodiment, the list of NAS messages include:
REGISTRATION REQUEST message;
DEREGISTRATION REQUEST message;
SERVICE REQUEST message; and
CONTROL PLANE SERVICE REQUEST.
IDENTITY REQUEST
AUTHENTICATION REQUEST;
AUTHENTICATION RESULT;
AUTHENTICATION REJECT;
REGISTRATION REJECT
REGISTRATION ACCEPT
DEREGISTRATION ACCEPT
SERVICE REJECT
SERVICE ACCEPT
UE CONFIGURATION UPDATE command
UE PARAMETERS UPDATE command
ATTACH REQUEST
ATTACH ACCEPT
ATTACH REJECT
TRACKING AREA UPDATE REQUEST
TRACKING AREA UPDATE REJECT
TRACKING AREA UPDATE ACCEPT
DETACH REQUEST
DETACH ACCEPT
DETACH REJECT
PDN CONNECTIVITY REQUEST
PDN CONNECTIVITY ACCEPT
PDN CONNECTIVITY REJECT
PDU SESSION ESTABLISHMENT REQUEST
PDU SESSION ESTABLISHMENT ACCEPT
PDU SESSION ESTABLISHMENT REJECT

In an embodiment the term EMM sublayer states are at least one of the below:
1) EMM-NULL
2) EMM-DEREGISTERED
a) EMM-DEREGISTERED.NORMAL-SERVICE
b) EMM-DEREGISTERED.LIMITED-SERVICE
c) EMM-DEREGISTERED.ATTEMPTING-TO-ATTACH
d) EMM-DEREGISTERED.PLMN-SEARCH
e) EMM-DEREGISTERED.NO-IMSI
f) EMM-DEREGISTERED.ATTACH-NEEDED
g) EMM-DEREGISTERED.NO-CELL-AVAILABLE
h) EMM-DEREGISTERED.eCALL-INACTIVE
3) EMM-REGISTERED-INITIATED
4) EMM-REGISTERED
a) EMM-REGISTERED.NORMAL-SERVICE
b) EMM-REGISTERED.ATTEMPTING-TO-UPDATE
c) EMM-REGISTERED.LIMITED-SERVICE
d) EMM-REGISTERED.PLMN-SEARCH
e) EMM-REGISTERED.UPDATE-NEEDED
f) EMM-REGISTERED.NO-CELL-AVAILABLE
g) EMM-REGISTERED.ATTEMPTING-TO-UPDATE-MM
h) EMM-REGISTERED.IMSI-DETACH-INITIATED
5) EMM-DEREGISTERED-INITIATED
6) EMM-TRACKING-AREA-UPDATING-INITIATED
7) EMM-SERVICE-REQUEST-INITIATED

In an embodiment, the term 5GMM sublayer state is at least one of the below:
1) 5GMM-NULL
2) 5GMM-DEREGISTERED
a) 5GMM-DEREGISTERED.NORMAL-SERVICE
b) 5GMM-DEREGISTERED.LIMITED-SERVICE
c)5GMM-DEREGISTERED.ATTEMPTING-REGISTRATION
d) 5GMM-DEREGISTERED.PLMN-SEARCH
e) 5GMM-DEREGISTERED.NO-SUPI
f) 5GMM-DEREGISTERED.NO-CELL-AVAILABLE
g) 5GMM-DEREGISTERED.eCALL-INACTIVE
h) 5GMM-DEREGISTERED.INITIAL-REGISTRATION-NEEDED
3) 5GMM-REGISTERED-INITIATED
4) 5GMM-REGISTERED
a) 5GMM-REGISTERED.NORMAL-SERVICE
b) 5GMM-REGISTERED.NON-ALLOWED-SERVICE
c)5GMM-REGISTERED.ATTEMPTING-REGISTRATION-UPDATE
d) 5GMM-REGISTERED.LIMITED-SERVICE
e) 5GMM-REGISTERED.PLMN-SEARCH
f) 5GMM-REGISTERED.NO-CELL-AVAILABLE
g) 5GMM-REGISTERED.UPDATE-NEEDED
5) 5GMM-DEREGISTERED-INITIATED
6) 5GMM-SERVICE-REQUEST-INITIATED

Visited PLMN (VPLMN): This is a PLMN different from the HPLMN (if the EHPLMN list is not present or is empty) or different from an EHPLMN (if the EHPLMN list is present).

Allowable PLMN: In the case of an MS operating in MS operation mode A or B, this is a PLMN which is not in the list of “forbidden PLMNs” in the MS. In the case of an MS operating in MS operation mode C or an MS not supporting A/Gb mode and not supporting Iu mode, this is a PLMN which is not in the list of “forbidden PLMNs” and not in the list of “forbidden PLMNs for GPRS service” in the MS.

Available PLMN: PLMN(s) in the given area which is/are broadcasting capability to provide wireless communication services to the UE.

Camped on a cell: The MS (ME if there is no SIM) has completed the cell selection/reselection process and has chosen a cell from which it plans to receive all available services. Note that the services may be limited, and that the PLMN or the SNPN may not be aware of the existence of the MS (ME) within the chosen cell.

EHPLMN: Any of the PLMN entries contained in the Equivalent HPLMN list.

Equivalent HPLMN list: To allow provision for multiple HPLMN codes, PLMN codes that are present within this list shall replace the HPLMN code derived from the IMSI for PLMN selection purposes. This list is stored on the USIM and is known as the EHPLMN list. The EHPLMN list may also contain the HPLMN code derived from the IMSI. If the HPLMN code derived from the IMSI is not present in the EHPLMN list then it shall be treated as a Visited PLMN for PLMN selection purposes.

Home PLMN: This is a PLMN where the MCC and MNC of the PLMN identity match the MCC and MNC of the IMSI.

Registered PLMN (RPLMN): This is the PLMN on which certain LR (location registration which is also called as registration procedure) outcomes have occurred. In a shared network the RPLMN is the PLMN defined by the PLMN identity of the CN operator that has accepted the LR.

Registration: This is the process of camping on a cell of the PLMN or the SNPN and doing any necessary LRs.

UPLMN: PLMN/access technology combination in the “User Controlled PLMN Selector with Access Technology” data file in the SIM (in priority order).

OPLMN: PLMN/access technology combination in the “Operator Controlled PLMN Selector with Access Technology” data file in the SIM (in priority order) or stored in the ME (in priority order).

In an embodiment, the term RAT as defined may be one of the following:
NG-RAN
5G, 4G, 3G, 2G
EPS, 5GS
NR
NR in unlicensed bands
NR(LEO) satellite access
NR(MEO) satellite access
NR(GEO) satellite access
NR(OTHERSAT) satellite access
NR RedCap
E-UTRA
E-UTRA in unlicensed bands
NB-IoT
WB-IoT
LTE-M

In an embodiment, 5GS registration type are:
initial registration
mobility registration updating
periodic registration updating
emergency registration
SNPN onboarding registration
“disaster roaming initial registration; or
“disaster roaming mobility registration updating”

In an embodiment, not set the registration type to disaster roaming initial registration or disaster roaming mobility registration updating means 5GS registration type is set to value other than “disaster roaming initial registration” or “disaster roaming mobility registration updating” at least one of:
initial registration
mobility registration updating
periodic registration updating
emergency registration
SNPN onboarding registration

### PLMN Selection as Per 23.122 Without RPLMN

The MS selects and attempts registration on any PLMN/access technology combinations, if available and allowable, in the following order:
either the HPLMN (if the EHPLMN list is not present or is empty) or the highest priority EHPLMN that is available (if the EHPLMN list is present);
each PLMN/access technology combination in the “User Controlled PLMN Selector with Access Technology” data file in the SIM (in priority order);
each PLMN/access technology combination in the “Operator Controlled PLMN Selector with Access Technology” data file in the SIM (in priority order) or stored in the ME (in priority order);
other PLMN/access technology combinations with received high quality signal in random order;
Other PLMN/access technology combinations in order of decreasing signal quality.

### PLMN Selection as Per 23.122 With RPLMN

The MS selects and attempts registration on any PLMN/access technology combinations, if available and allowable, in the following order:
either the RPLMN or the Last registered PLMN;
either the HPLMN (if the EHPLMN list is not present or is empty) or the highest priority EHPLMN that is available (if the EHPLMN list is present);
each PLMN/access technology combination in the “User Controlled PLMN Selector with Access Technology” data file in the SIM (in priority order);
each PLMN/access technology combination in the “Operator Controlled PLMN Selector with Access Technology” data file in the SIM (in priority order) or stored in the ME (in priority order);
other PLMN/access technology combinations with received high quality signal in random order;
other PLMN/access technology combinations in order of decreasing signal quality.

The network apparatus (202) used in this embodiment is explained using any 5G Core Network Function for e.g. AMF or LTE Core Network Function for e.g. MME. However, the network apparatus (202) could be any 5G/EUTRAN Core Network Entities like AMF/SMF/MME/UPF or the Network could be any 5G/EUTRAN RAN Entity like eNodeB (eNB) or gNodeB (gNB) or NG-RAN etc. The messages used or indicated in this embodiment are shown as an example. The messages could be any signaling messages between the UE (102) and the network functions/entities or between different network functions/entities. The term area/location/geographical area are used in this embodiment may refer to any of cell/cell ID, TAC/TAI, PLMN, MCC/MNC, Latitude/longitude, CAG cell or any geographical location/coordinate. The methods, issues or solutions disclosed in this embodiment are explained using NR access or NG-RAN Access Technology as an example and is not restricted or limited to NR access only. The methods, issues or solutions disclosed in this embodiment are explained using LTE access or E-UTRAN as an example and is not restricted or limited to LTE access only.

However, the solutions proposed in this embodiment are also applicable for E-UTRAN access Technology, Narrow Band (NB)-S1 mode or Wide Band (WB)-S1 mode via E-UTRAN access and/or Narrowband Internet Of Things (NB-IOT) or Wideband Internet Of Things (WB-IOT) Access/Architecture. The solutions which are defined for NR (5GC) are also applicable to legacy RATs like E-UTRA/LTE, the corresponding CN entities needs to be replaced by LTE entities for e.g. AMF with MME, g-nodeB with e-nodeB, UDM with HSS etc. But principles of the solution remain same. The network apparatus (202) used in this embodiment is explained using any 5G Core Network Function for e.g. AMF. However, the network apparatus (202) could be any 5G/EUTRAN Core Network Entities like AMF/SMF/MME/UPF or the network apparatus (202) could be any 5G/EUTRAN RAN Entity like eNodeB (eNB) or gNodeB (gNB) or NG-RAN etc. The messages used or indicated in this embodiment are shown as an example. The messages could be any signaling messages between the UE (102) and the network functions/entities or between different network functions/entities.

As used herein, the term “network” may refer to one or more of a Public Land Mobile Network (PLMN) or a Radio Access Technology (RAT) or an access or a system or a Radio Access Network (RAN) or a band or a frequency or a cell or a Network entity or a Core Network (CN) entity or a Network function or any Terrestrial Network or any Non-Terrestrial Network or any component of the network. The solutions and procedures defined in this embodiment are illustrated using 5G or LTE as an example. It could be any applicable for any RAT(s)/Access but the core principles remains the same. The solutions and procedures defined in this embodiment are illustrated using one of cell(s), RAT(s), PLMN(s) and Access(es) as an example. It could be applicable for any Network or Network Entity and the core principle remains the same. The solutions which are defined for LTE (EPC) are also applicable to other RATs like NR/NG-RAN/5GC, the corresponding CN entities needs to be replaced by NR entities for e.g. MME with AMF, e-nodeB with g-nodeB, HSS with UDM etc. But principles of the solution remain same. Similarly, the corresponding long term evolution (LTE) procedures needs to be replaced by NR procedures (e.g. Attach/TAU procedure with Registration Procedure/Registration procedure for mobility registration updating, Detach Procedure with Deregistration procedure and so on). But principles of the solution remain same. The cause names in this embodiment are for illustration purpose and it can have any name. The non access stratum (NAS) messages and access stratum (AS) messages described in this embodiment is only for illustration purpose it can be any NAS or AS messages as per defined protocol between UE and AMF/MME or UE and gNB (NG-RAN/any RAN node)/eNB.

The solution explained in this embodiment is also applicable to an E-UTRAN cell with satellite access for Cellular IoT (CIoT) or a NG-RAN cell with satellite access for Cellular IoT (CIoT).

The terms camp and register are used interchangeably and have the same meaning. The terms wait timer, DisCo wait timer, Discontinuous Coverage wait timer, Random timer, Random wait timer, Discontinuous Coverage wait (DCW) Timer are all used interchangeably and have the same meaning. The terms wait range, Disco Wait Range, Discontinuous Coverage Wait Range, DCW Range are all used interchangeably and have the same meaning. The term area as used in this embodiment may refer to any of cell/cell ID, TAC/TAI, PLMN, MCC/MNC, Latitude/longitude, any CAG/CAG identifier or any geographical location/coordinate. For the list of possible NAS messages please refer to 3GPP TS 24.501 or 3GPP TS 24.301, for list of AS messages please refer to 3GPP TS 38.331 or 3GPP TS 36.331. The cause names in this embodiment are for illustration purpose and it can have any name.

The non-access stratum (NAS) messages and access stratum (AS) messages described in this embodiment is only for illustration purpose it can be any NAS or AS messages as per defined protocol between the UE (102) and AMF/MME or the UE (102) and gNB(NG-RAN/any RAN node)/eNB. In this embodiment, the term satellite is used interchangeably with 5G or 4G system with satellite access and is used to represent any satellite(s) or constellation of satellites(s) or any aerial body/satellite in any of the satellite orbits (for example, LEO/MEO/GEO/HEO etc.) or any 5G system with satellite access or 4G System with satellite Access or any RAN entity or core network entity or any network function(s) associated with the satellite Access/RAT/PLMN/network.

Serving satellite: a satellite providing the satellite access to the UE (102). In the case of Non-Geostationary Satellite Orbit (NGSO), the serving satellite is always changing due to the nature of the constellation.

Store & Forward Satellite operation: in the context of this study, it is an operation mode of a 5G system with satellite-access where the 5G system can provide some level of service (in storing and forwarding the data) when satellite connectivity is intermittently/temporarily unavailable, e.g. to provide communication service for UEs under satellite coverage without a simultaneous active feeder link connection to the ground segment.

S&F data retention period: it is the data storage validity period for the 5G system with satellite access supporting store and forward operation (e.g. after which undelivered data stored is being discarded).

UE-Satellite-UE Communication: for the 5G system with satellite access, it refers to the communication between UEs under the coverage of one or more serving satellites, using satellite access without going through the ground segment.

In an embodiment, the UE (102) can indicate its support for S&F mechanism (i.e. whether S&F mechanism is supported or not) to the network apparatus (202)/satellite (i.e. 4G or 5G system with Satellite access) in any of the information element (IE) or messages (e.g. UE capability inquiry/information message) or any AS or NAS signaling messages/procedures (e.g. Registration procedure (for example, Registration Request Message) or Attach procedure (for example, Attach Request Message) or TAU procedure (e.g. TAU Request message)).

In an embodiment, the network apparatus (202) can enquire the capability of the UE (102) for the S&F operation in any AS or NAS signaling messages (such as registration procedure or attach procedure or UE Configuration Update (UCU) Command Procedure or UE Parameters Update (UPU) Command Procedure or Tracking Area Update (TAU) procedure etc.). The UE (102) can indicate/respond/negotiate its support for Store and Forward operation (i.e. whether S&F mechanism is supported or not) with the network apparatus (202) in any AS and NAS signaling messages.

In an embodiment, the UE (102) and the network apparatus (202) can negotiate the capability of S&F operation for the UE (102) in any of the AS or NAS signaling message or procedure.

A 5G/4G system/network with satellite access can indicate or broadcast its capability for S&F operation or to operate in S&F mode (i.e. whether S&F mechanism is supported or not), optionally when feeder link is not available, in any of the broadcast messages (e.g. MIB or SIB messages (e.g. SIB19, SIB31, SIB32 or any of the existing or new SIB messages) or any of the AS or NAS signaling messages or procedure (for example, Registration procedure (for example, Registration Accept Message) or Attach procedure (for example, Attach Accept Message) or UE Configuration Update (UCU) Command Procedure or UE Parameters Update (UPU) Command Procedure or Tracking Area Update (TAU) procedure (e.g. TAU Accept message etc.).

In an embodiment, the network apparatus (202) may indicate its support for S&F mechanism/operation only when feeder link is not available.

The UE (102) and/or the network apparatus (202) may indicate/negotiate the S&F support/capability for either the UE (102) or the network apparatus (202) or for both the UE (102) and the network apparatus (202), on a per UE basis (e.g. Network may support S&F operation for some of the UE(s) and may not support S&F operation for other UE(s)) or/and on a per application basis (such as SMS, voice mail, etc. For instance, the UE (102) or the network apparatus (202) may support S&F for some applications while the UE (102) and the network apparatus (202) may not support S&F for other applications) and/or on a per satellite basis (e.g. Some UE(s) may support S&F for some Satellite(s) while those UE(s) may not support S&F for other Satellite(s) and/or on a per timeslot basis (e.g. S&F operation may be allowed for certain time slots and may not be allowed or supported at other time slots).

In an embodiment, some satellite from a constellation of satellite(s) may support S&F while other satellite(s) which may be a part of the same constellation of the satellites may not support S&F for the same/other UE(s), and/or a per PLMN/RAT basis (for example, a Satellite may support S&F for certain PLMN(s) while the same satellite(s) may not support S&F for other PLMN(s)) and/or a per combination basis of any of these parameter(s). In an embodiment, the UE (102) may indicate its support for S&F operation to the network apparatus (202), which may give or indicate the same support or different support (i.e. Not supported) for S&F operation to the UE (102) in any of the AS OR NAS signaling messages. In an embodiment, the network apparatus (202) may give or indicate the support for S&F operation to the UE (102) in any of the AS OR NAS signaling messages, when the network apparatus (202) determines that it support S/F operation, optionally for this UE (102), optionally without the UE (102) indicating the support for S/F operation or mode.

The UE (102) and/or the network apparatus (202) may indicate/negotiate the S&F support/capability for either the UE (102) or the network apparatus (202) or for both the UE (102) and the network apparatus (202), on a per location basis (like per TAI or/and per LAI or/and per country or/and per time zone or/and per time slot or/and per PLMN or/and geographical coordinates etc. For example, the UE(s) and/or the Satellite(s)/network apparatus (202) may configure or negotiate their capability for S&F operation as per the current location or for any specific location and the S&F capability may be applicable for only those location. The S&F capability of the UE(s) and/or the Network(s)/Satellite(s) may change if the location being referenced or used is changed). For example, the UE(s) and/or the Satellite(s) may configure or negotiate their capability or capacity for S&F operation as per a given or negotiated/indicated time slot and the Store & Forward capability may be applicable for only those time slot. The S&F capability of the UE(s) and/or the Network(s)/Satellite(s) may change if the time slot being referenced or used changes or the time slot is over. The S&F capability/support of the UE (102) and/or the Network apparatus (202) may change (e.g. the UE (102) and/or the Network apparatus (202) may switch from S&F mode to normal mode or the vice-versa (e.g. normal mode to S&F mode)) if the location and/or time and/or feeder link availability status changes (e.g. feeder link availability status changes from feeder link not available to feeder link available or vice-versa (e.g. feeder link available to feeder link not available)).

The UE (102) and/or the network apparatus (202) may indicate/negotiate the S&F support/capability for either the UE (102) or the network apparatus (202) or for both the UE (102) and the network apparatus (202), based on the UE's subscription or based on operator/network's local policies or configuration or based on any regulatory requirements or policies. The S&F capabilities of the UE(s) and/or the Network/Satellite(s) may be based on any of the above listed parameter(s) in any order or combination.

The UE (102) may be preconfigured with the support for S&F mechanism (i.e. whether S&F mechanism is supported or not). The pre-configuration may be stored in the SIM or the device (USIM/ME) or may be configured using any configuration update from the network/satellite (e.g. SIM REFRESH etc.).

In an embodiment, the network apparatus (202)/satellite may pre-configure the UE(s) with the S&F operation (e.g. in USIM or ME or using any subscription or any method/procedure) or the network apparatus (202)/Satellite can configure the UE (102) with the support for S&F mechanism in any AS or NAS signaling messages (such as Registration procedure or Attach procedure or UE Configuration Update (UCU) Command Procedure or UE Parameters Update (UPU) Command Procedure etc.)

A 5G/4G system/network with satellite access may configure/pre-configure/indicate/negotiate the support for S&F mechanism for the UE (102) or the network apparatus (202) or both the UE (102) and the network apparatus (202) based on the priority of the UE (102) (for example, based on the priority of the UE (102), the network apparatus (202) may configure the support for S&F from the UE (102) side or the network apparatus (202) side or both the UE (102) and network apparatus (202) side for High Priority UE(s) and may not configure the support for S&F for low priority UE(s)) and/or the UE type (e.g. Based on the type of the UE(s) or UE type, some UE(s) like IOT devices may be configured with S&F operation (UE's side support or network apparatus (202) side support or both) while other UE(s) like smartphones may not be configured with S&F operation) and/or UE usage pattern (e.g. Data Centric UE(s) and Voice Centric UE(s) may be configured with different S&F operation support) and/or data/packet type (e.g. Data packets and voice packets may be treated with different S&F Support).

A 5G/4G system/network with satellite access may or may not provide support or configure the support for S&F mechanism for the UE (102) based on the current conditions of the network apparatus (202) or deployment or topology (For example, during congestion, the network apparatus (202) may disable the support for S&F operation from Network/UE/Both the sides temporarily and may enable the support for S&F later).

A 5G/4G system/network with satellite access may configure/indicate the UE (102) with the support/subscription/configuration for S&F mechanism/operation from the UE/Network/Both the UE (102) and the network apparatus (202) perspective using any Network Functions or entity (e.g. like AMF/MME, SMF, UPF, AF, UDM/HSS, etc.) (For example, the UDM/HSS may configure the AMF/MME with the support for S&F operation for UE/Network/Both side and the AMF/MME may indicate/configure the support status of S&F operation to the UE (102). In an embodiment, the network apparatus (202) (e.g. UDM/HSS etc.) may store the S&F support for the UE (102) as a part of UE subscription and may decide the S&F support for the UE (102) based on the UE's subscription. In an embodiment, the UE (102) may store the S&F support as a part of UE's subscription and may decide the S&F support/indication (e.g. whether S&F support needs to be indicated to the network apparatus (202) or not) based on the UE's subscription. In an embodiment, the PCF may configure the AMF/MME with the support for S&F operation for UE/Network/Both side and the AMF/MME may indicate/configure the support status of S&F operation to the UE. In an embodiment, the application function (AF) may configure/indicate the support for S&F operation to the UE (102) directly or via any other network function, optionally on a per application basis.

The UE (102) and/or the network apparatus (202) may not allow the S&F operation (e.g. S&F operation or S&F mode may be restricted) for any critical/priority data (for example, emergency call), which may not be delay tolerant or may need immediate attention or may need to be forwarded immediately. In an embodiment, the UE (102) and/or the network apparatus (202) may indicate/negotiate the list of services for which S&F services are supported and the list of services for which S&F services are restricted. The UE (102) and/or the network apparatus (202) may decide the S&F support for each service.

The S&F capability of the UE (102)/network apparatus (202) or both may be decided based on the satellite coverage availability information, the satellite/satellite constellation deployment, the S&F capability of the serving satellite/all the satellite in the satellite constellation, the ISL existence or capability of the serving satellite/all the satellites in the satellite constellation, the feeder link availability period of the satellites and other similar parameters and factors.

The UE (102) and the network apparatus (202) can negotiate/indicate the max volume of data (e.g. S&F data storage quota) or/and data validity (e.g. S&F data retention period) for S&F operation for the UE (102) in any of the AS or NAS signaling message or procedure(for example, registration procedure (for example, Registration Request/Accept Message) or Attach procedure (for example, Attach Request/Accept Message) or UE Configuration Update (UCU) Command Procedure or UE Parameters Update (UPU) Command Procedure or Tracking Area Update (TAU) procedure (e.g. TAU Request/Accept message etc.).

A 5G/4G system/network with Satellite access can indicate the max volume of data (for example, S&F data storage quota) or/and data validity (for example, S&F data retention period) for S&F operation, optionally when feeder link is not available, in any of the AS or NAS signaling messages or procedure (for example, Registration procedure (for example, Registration Accept Message) or Attach procedure (for example, Attach Accept Message) or UE Configuration Update (UCU) Command Procedure or UE Parameters Update (UPU) Command Procedure or Tracking Area Update (TAU) procedure (e.g. TAU Accept message) etc.).

In an embodiment, the network apparatus (202) may indicate the max volume of data (e.g. S&F data storage quota) or/and data validity (e.g. S&F data retention period) for S&F operation only when feeder link is not available. In an embodiment, the UE (102) may indicate the max volume of data (for example, S&F data storage quota) or/and data validity (e.g. S&F data retention period) for S&F operation to the network apparatus (202) in any AS or NAS signaling messages (e.g. Registration Request message or Attach Request message or TAU request message etc.) and the network apparatus (202) may give or indicate the same values/configurations or different values/configurations (for example, more or less value of quota/timers/retention period) for the max volume of data (for example, S&F data storage quota) or/and data validity (for example, S&F data retention period) for S&F operation to the UE (102) in any of the AS OR NAS signaling messages.

In an embodiment, the network apparatus (202) may give or indicate the max volume of data (for example, S&F data storage quota) or/and data validity (for example, S&F data retention period) for S&F operation to the UE (102) in any of the AS OR NAS signaling messages, when the network apparatus (202) determines that the network support S&F operation, optionally for this UE (102), optionally without the UE (102) indicating the support for S/F operation or mode or without the UE (102) indicating/requesting the max volume of data (for example, S&F data storage quota) or/and data validity (for example, S&F data retention period) for S&F operation.

The UE (102) and/or the network apparatus (202) may indicate/negotiate the max volume of data (for example, S&F data storage quota) or/and data validity (for example, S&F data retention period) for either the UE (102) or the network apparatus (202) or for both the UE (102) and the network apparatus (202) on a per UE basis (for example, the network apparatus (202) may provide higher max volume of data (for example, S&F data storage quota) or/and higher data validity (for example, S&F data retention period) for some of the UE(s) and may provide lower max volume of data (for example, S&F data storage quota) or/and lower data validity (for example, S&F data retention period)) for S&F operation for other UE(s) or/and on a per application basis (such as SMS, voice mail, etc. For instance, the UE (102) or the network apparatus (202) may provide higher max volume of data (for example, S&F data storage quota) or/and higher data validity (for example, S&F data retention period)) for some applications while the UE (102) and network apparatus (202) may provide lower max volume of data (for example, S&F data storage quota) or/and lower data validity (for example, S&F data retention period) for other applications and/or on a per satellite basis (for example, Some UE(s) may provide higher max volume of data (for example, S&F data storage quota) or/and higher data validity (for example, S&F data retention period) for some Satellite(s) while those UE(s) may provide lower max volume of data (for example, S&F data storage quota) or/and lower data validity (for example, S&F data retention period)) for other Satellite(s) and/or on a per timeslot basis (for example, S&F operation Network may provide higher max volume of data (for example, S&F data storage quota) or/and higher data validity (for example, S&F data retention period) a for certain time slots and may provide lower max volume of data (for example, S&F data storage quota) or/and lower data validity (for example, S&F data retention period)) at other time slots.

In an embodiment, some satellite from a constellation of satellite(s) may provide higher max volume of data (for example, S&F data storage quota) or/and higher data validity (for example, S&F data retention period) while other satellite(s) which may be a part of the same constellation of the satellites may provide lower max volume of data (for example, S&F data storage quota) or/and lower data validity (for example, S&F data retention period) for the same/other UE(s), and/or a per PLMN/RAT basis (for example, a satellite may provide higher max volume of data (for example, S&F data storage quota) or/and higher data validity (for example, S&F data retention period) for certain PLMN(s) while the same satellite(s) may provide lower max volume of data (for example, S&F data storage quota) or/and lower data validity (for example, S&F data retention period) for other PLMN(s) and/or a per combination basis of any of these parameter(s).

The UE (102) and/or the network apparatus (202) may indicate/negotiate the max volume of data (for example, S&F data storage quota) or/and data validity (for example, S&F data retention period) for either the UE (102) or the network apparatus (202) or for both the UE (102) and the network apparatus (202), on a per location basis (like per TAI or/and per LAI or/and per country or/and per time zone or/and per timeslot or/and per PLMN or/and geographical coordinates etc.). For example, the UE(s) and/or the satellite(s) may configure or the network apparatus (202) may provide certain max volume of data (for example, S&F data storage quota) or/and data validity (for example, S&F data retention period) as per the current location or for any specific location and the S&F capability may be applicable for only those location. The S&F configurations of the UE(s) and/or the Network(s)/Satellite(s) may change if the location being referenced or used changes. For example, the UE(s) and/or the satellite(s) may configure or the network apparatus (202) may provide certain max volume of data (for example, S&F data storage quota) or/and data validity (for example, S&F data retention period) as per a given or negotiated/indicated time slot and the max volume of data (for example, S&F data storage quota) or/and data validity (for example, S&F data retention period) or other capability may be applicable for only those timeslot. The indicated/negotiated max volume of data (for example, S&F data storage quota) or/and data validity (for example, S&F data retention period) of the UE(s) and/or the network(s)/satellite(s) may change if the time slot being referenced or used changes or the time slot is over.

The UE (102) and/or the network apparatus (202) may indicate/negotiate the max volume of data (for example, S&F data storage quota) or/and data validity (for example, S&F data retention period) for either the UE (102) or the network apparatus (202) or for both the UE (102) and the network apparatus (202), based on the UE's subscription or based on operator/network's local policies or configuration or based on any regulatory requirements or policies. The S&F configurations of the UE(s) and/or the network/satellite(s) may be based on any of the above listed parameter(s) in any order or combination.

The UE (102) may be preconfigured with the max volume of data (for example, S&F data storage quota) or/and data validity (for example, S&F data retention period). The pre-configuration may be stored in the SIM or the device (USIM/ME) or may be configured using any configuration update from the network/satellite (e.g. SIM REFRESH etc.).

A 5G/4G system/network with satellite access may configure/pre-configure/indicate/negotiate the max volume of data (for example, S&F data storage quota) or/and data validity (for example, S&F data retention period) for S&F mechanism for the UE (102) or the network apparatus (202) or both the UE (102) and the network apparatus (202) based on the priority of the UE (102) or UE priority (for example, based on the priority of the UE (102), the network apparatus (202) may configure higher max volume of data (for example, S&F data storage quota) or/and higher data validity (for example, S&F data retention period)). For S&F from UE side or Network side or both the UE (102) and the network apparatus (202) side for high priority UE(s) and may configure lower max volume of data (for example, S&F data storage quota) or/and lower data validity (for example, S&F data retention period) for low priority UE(s) and/or the UE type. For example, based on the type of the UE(s) or UE type, some UE(s) like IOT devices may be configured with lower max volume of data (for example, S&F data storage quota) or/and lower data validity (for example, S&F data retention period) (the UE (102) side support or the network apparatus (202) side support or both) while other UE(s) like smartphones may be configured with higher max volume of data (for example, S&F data storage quota) or/and higher data validity (for example, S&F data retention period) and/or UE usage pattern (for example, Data Centric UE(s) and voice centric UE(s) may be configured with max volume of data (for example, S&F data storage quota) or/and data validity (for example, S&F data retention period) and/or data/packet type (for example, data packets and voice packets may be treated with different max volume of data (for example, S&F data storage quota) or/and data validity (for example, S&F data retention period)).

A 5G/4G system/network with satellite access may configure/indicate the UE (102) with the max volume of data (for example, S&F data storage quota) or/and data validity (for example, S&F data retention period) for S&F mechanism/operation from the UE/Network/Both the UE (102) and the network apparatus (202) perspective using any network functions or entity (for example, like AMF/MME, SMF, UPF, AF, UDM/HSS, etc.). For example, the UDM/HSS may configure the AMF/MME UE with the max volume of data (for example, S&F data storage quota) or/and data validity (e.g. S&F data retention period) for UE/Network/Both side and the AMF/MME may indicate/configure UE with the max volume of data (for example, S&F data storage quota) or/and data validity (for example, S&F data retention period) to the UE (102).

In an embodiment, the PCF may configure the AMF/MME with the max volume of data (for example, S&F data storage quota) or/and data validity (for example, S&F data retention period) for UE/Network/Both side and the AMF/MME may indicate/configure with the max volume of data (for example, S&F data storage quota) or/and data validity (for example, S&F data retention period) to the UE (102). In an embodiment, the application function (AF) may configure/indicate with the max volume of data (for example, S&F data storage quota) or/and data validity (for example, S&F data retention period) to the UE (102) directly or via any other network function, optionally on a per application basis.

In an embodiment, the S&F parameters values configured by the network apparatus (202) to the UE (102) may also take into consideration the value of the data validity timer, the satellite coverage availability information, the satellite/satellite constellation deployment, the S&F capability of the serving satellite/all the satellite in the satellite constellation, the ISL existence or capability of the serving satellite/all the satellites in the satellite constellation, the feeder link availability period of the satellites and other similar parameters and factors.

The UE (102), if operating in S&F mode, may attempt retransmission of the data/packets, optionally for any critical/priority data, if the UE (102) is camped on any other Network/RAT/PLMN/Access or any other satellite which has feeder link available

A 5G/4G system/network/network apparatus (202) with satellite access may discard the data received from the UE (102) if it has exceeded the max volume of data (for example, S&F data storage quota) per the UE (102) and/or has exceeded overall max data volume/capacity per satellite (for example, data storage limit of the satellite is exhausted) and/or per location and/or per application based on the UE priority and/or data type and/or application type and/or data priority. In an embodiment, the network apparatus (202) may indicate to the UE (102) that the stored data/signaling is discarded if any of stored data/signaling is discarded due to any reasons (e.g. due to S&F data storage quota is over or S&F data storage quota for the UE (102) is over or S&F data storage quota of the network apparatus (202), optionally for this time or location, is exhausted or S&F data retention period is over or S&F data retention period for the UE (102) is over etc.

In an embodiment, the 5G/4G system/network with satellite access may keep the data if it exceeds the max volume of data (for example, S&F data storage quota) per the UE (102) and/or per satellite and/or per location and/or per application based on the UE priority and/or data priority and/or application type. (for example, if the data storage capacity/quota is exhausted per the UE (102) or per satellite or per location or per any of the parameters like per application, the network apparatus (202)/satellite may still store the data from the UE (102) if it is a priority UE or the data is a critical/priority data such as Emergency SMS data etc. and the network apparatus (202) may discard any other existing stored non-priority or less priority data or any data from low/non priority UE and inform/indicate to the affected UE/Data entity if possible.

A 5G/4G system/network with satellite access may forward the stored data/signaling to the ground station (for example, when feeder link is available) or to the UE (102) (for example, when service link is available) or to other satellite system (for example, when ISL is supported and available) based on either the UE (102) priority/Priority of the UE(s) or type of the UE(s) or subscription of the UE(s) (for example, data for higher priority UE(s) may be forwarded first than the data of lower/non priority UE(s)) and/or data priority and/or data expiry timer(for example, S&F data retention period) and/or based on the application type/application priority and/or based on the priority of the data (for example, high priority data, for example, emergency data or SMS etc. may be forwarded first in comparison to low priority data) and/or based on the type of data (for example, UL/DL or MO/MT data) (for example, UL/Stored data may be forwarded first and then DL/MT data may be received or UL and DL Data rates or Data path may be adjusted accordingly) and/or based on the type of the user(s) (for example, data for current serving users may be forwarded first/before than the data for the stored users) and/or on the basis of the data validity/retention timer expiry or data storage quota.

In an embodiment, the terms 5G/4G system/network with satellite access, satellite, network and network apparatus (202) are used interchangeably and have the same meaning. These terms are used to represent a network node or a network entity or a network function, as described in this embodiment. The network apparatus/node/entity/function is present either on-board the satellite and/or on the ground and/or both on the satellite and/or the ground.

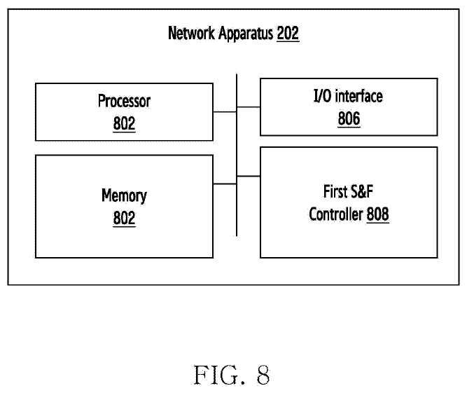

FIG. 8 is a block diagram that illustrates a schematic of the network apparatus (202) implemented to carry out the disclosed subject matter according to an embodiment of the disclosure.

Referring to FIG. 8, as shown, the network apparatus (202) includes a processor (802), memory (804), an input output (I/O) interface (806), and a first S&F controller (808). Each component is explained in further detail below.

The processor (802) communicates with the memory (804), the I/O interface (806) and the first S&F controller (808). The processor (802) is configured to execute instructions stored in the memory (804) and to perform various processes. The processor (802) may include one or a plurality of processors, may be a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The memory (804) includes storage locations to be addressable through the processor (802). The memory (804) is not limited to volatile memory and/or non-volatile memory. Further, the memory (804) may include a plurality of computer-readable storage media. The memory (804) may include non-volatile storage elements. For example, non-volatile storage elements may include magnetic hard discs, optical discs, floppy discs, flash memories, or forms of electrically programmable memories (EPROM) or electrically erasable and programmable (EEPROM) memories.

The I/O interface (806) transmits the information between the memory (804) and external peripheral devices. The peripheral devices are the input-output devices associated with the network apparatus (202). Further, the first S&F controller (808) communicates with the I/O interface (806) and the memory (804). The first S&F controller (808) may be communicatively coupled to the memory (804) and the processor (802). The first S&F controller (808) is an innovative hardware that is realized through the physical implementation of both analog and digital circuits, including logic gates, integrated circuits, microprocessors, microcontrollers, memory circuits, passive and active electronic components, as well as optical components.

In an embodiment, the first S&F controller (808) detects whether the network apparatus (202) is operating in a store & forward (S&F) satellite operation mode or in a normal mode or default mode. In the S&F satellite operation mode, the satellite temporarily stores the received data/signaling onboard (e.g. when feeder link is not available) and then forwards it to the intended ground station when it is within range (e.g. when feeder link is available) or forward it to the target UE (102) (e.g. when service link is available). This is particularly useful for communication between two points that may not have simultaneous access to the satellite. When the satellite passes over the ground network (104), it receives data from the ground network (104) and stores it in its onboard memory. When the satellite comes within the range of the destination ground network (104), it forwards the stored data to the ground network (104). In the normal mode or default mode, the satellite is fully operational and capable of carrying out its designated functions, such as communication, imaging, or scientific measurements.

In an embodiment, the first S&F controller (808) transmits a system information broadcasting system information block (SIB) message or a Master Information Broadcast Master Information Block (MIB) message to the UE (102) when the network apparatus (202) is operating in the S&F satellite operation mode. For instance, the SIB message may be a SIB31 message, a SIB32 message, a SIB19 message, an existing SIB message, a new SIB message, and the like. The SIB message provides scheduling information, which tells the UE (102) when other types of system information will be transmitted, and also provide synchronization information, allowing the UE (102) to align its timing with the network apparatus (202). The SIB31 message is used to broadcast information regarding the availability of neighboring networks to assist UEs that support dual connectivity (LTE and CDMA2000). The SIB32 message helps in managing seamless transitions between the UE (102) and the network apparatus (202), ensuring continuity of service when moving between areas with different coverage. The SIB19 message ensures that that the UEs in affected areas may receive critical safety information in a timely manner. The new SIB messages are introduced in newer network standard releases to support enhanced or new network capabilities. The SIB or MIB messages (e.g. SIB19, SIB31, SIB32, any existing/new SIB or MIB messages) may include a bit or an information element (IE) to indicate the S&F support or capability (e.g. supported or not supported) and/or a plurality of S&F parameters (e.g. S&F data storage quota, S&F data retention period etc.) to the UE (102).

In an embodiment, the first S&F controller (808) transmits a non-access stratum (NAS) signaling message to the UE (102) when the network apparatus (202) is operating in the S&F satellite operation mode. For example, the NAS signaling message includes, but not limited to an attach accept message, an attach reject message, a tracking area update (TAU) accept message, a TAU reject message, a service accept message, a service reject message, a registration accept message, a registration reject message, an authentication result message, an authentication reject message, a detach accept message, a deregistration accept message, a UE configuration update command (UCU) message, a UE parameters update command (UPU) message, a UE capability enquiry message, PDU session establishment accept, PDU session establishment reject, PDN Connectivity Accept, PDN Connectivity Reject, an existing NAS signaling message, a new NAS signaling message, and the like.

The attach accept message is sent by the network apparatus (202) to the UE (102) during the attach procedure, indicating that the UE (102) has successfully attached to the network apparatus (202). The attach reject message is sent by the network apparatus (202) to the UE (102) to reject the attach request. The attach reject message includes a cause code specifying the reason for rejection (for example, authentication failure, illegal UE, etc.). The TAU accept message is sent by the network apparatus (202) to the UE (102) to accept the TAU request. The TAU accept message confirms that the TAU was successful, and may provide a new tracking area list (TAL) and an updated location. The TAU reject message sent by the network apparatus (202) to reject the TAU request. The TAU reject message contains a cause code explaining the rejection (e.g., UE not authorized, unknown tracking area, etc.).

The service accept message is sent by the network apparatus (202) to the UE (102) to indicate that a requested service (for example, voice, data, etc.) can be provided. The service reject message is sent by the network apparatus (202) to the UE (102) to reject a requested service. The service reject message includes a cause code that explains why the service request was rejected (for example, service not allowed, congestion, etc.). The registration accept message is sent by the network apparatus (202) to confirm that the registration procedure of the UE (102) is successful. The registration reject message is sent by the network apparatus (202) to reject the registration procedure. The registration reject message includes a cause code specifying the reason for rejection (e.g., unauthorized, unknown network, etc.). The authentication result message is sent by the network apparatus (202) after successful authentication of the UE (102). The authentication result message confirms that authentication was successful and may include security context information for encryption and integrity protection. The authentication reject message is sent by the network apparatus (202) when the authentication fails. The authentication reject message contains a cause code indicating why authentication was rejected (for example, incorrect credentials, illegal UE, etc.).

The detach accept message is sent by the UE (102) to confirm that it has successfully detached from the network apparatus (202). The deregistration accept message is sent by the UE (102) to confirm successful deregistration from the network apparatus (202). The UCU message is sent by the network apparatus (202) to update the configuration settings of the UE (102). The UCU message provides updates related to network settings, such as frequency, mobility parameters, and radio access configurations. The UPU message is sent by the network apparatus (202) to update specific parameters associated with the UE (102).

The UE capability enquiry message is sent by the network apparatus (202) to request information about the capabilities (for example, supported frequency bands, carrier aggregation, data rates, etc.) of the UE (102). The existing NAS signaling message are NAS signaling messages defined in the existing LTE/5G specifications, used for functions like mobility management, session management, and security. Further, the new NAS signaling message refers to a signaling message introduced in updated standards to support new network features or capabilities.

In an embodiment, the first S&F controller (808) determines a support of the S&F satellite operation mode, a configuration of the S&F satellite operation mode, and a plurality of parameters of the S&F satellite operation mode. The support of the S&F satellite operation mode is indicated by an existing information element (IE), a new IE, an existing capability, a new capability, an existing parameter, a new parameter, a UE capability, a UE core network capability, a UE network capability, a feature flag, a support flag, a S&F support capability, a S&F support flag, a S&F feature support flag, a S&F indication, a S&F flag, and the like.

The existing IE is predefined unit of information used in signaling messages. It is part of the standard specifications and has been established in earlier versions of network protocols. The new IE is new unit of information introduced in updated versions of network specifications or standards. New IEs may be introduced to support new features, functionalities, or enhancements in network protocols. The existing capability is capability that the network apparatus (202) or the UE (102) already support, as defined by earlier 3GPP standards or specifications. The new capability is a capability that has been introduced in newer standards or updates to the existing protocol. The existing parameter is a parameter used in network protocols that has been defined in previous versions of the standards. The new parameter is a parameter introduced in recent updates to network protocols. The UE capability is a set of features and functionalities that the UE (102) supports. The UE core network capability is capabilities of the UE (102) related to its interaction with the core network.

The UE network capability is ability of the UE (102) to interact with different types of networks and access various services. The feature flag is indicator that signifies whether a particular feature is supported or not. The feature flag is used in network protocols and configurations to enable or disable specific features based on the capabilities of the UE (102) or the network apparatus (202). The support flag is a flag that indicates whether a certain functionality or feature is supported. It whether a given capability is available in the current network or UE context. The S&F support capability indicates whether the UE (102) or the network apparatus (202) supports Store and Forward (S&F) communication methods. The S&F support flag is a specific indicator within the signaling messages that shows if S&F support is enabled or not. The S&F feature supported flag is a flag that indicates whether the UE (102) or the network apparatus (202) supports specific features of the S&F communication mode. The S&F indication is a signaling message or element indicating the use or support of S&F functionality. Further, the S&F flag is a flag used to signify the presence or absence of S&F capabilities.

The plurality of parameters of the S&F satellite operation mode includes a S&F support capability, a S&F data storage quota, a S&F data retention period, a S&F data forwarding priority, and the like. The S&F support capability indicates whether the network apparatus (202) or the UE (102) supports S&F communication functionalities. This capability is important for scenarios where data needs to be temporarily stored on a satellite or network node and then forwarded to the intended destination. It ensures that the network apparatus (202) can handle the required storage and forwarding operations. The S&F data storage quota refers to the maximum amount of data that can be stored temporarily by the network apparatus (202) or the UE (102) using S&F capabilities. The S&F data retention period is a duration for which the data can be stored by the network apparatus (202) before it is forwarded or deleted. This period is crucial for ensuring timely delivery of data and managing storage efficiently. Data retention policies help in balancing between storage capacity and the need to forward data promptly.

The S&F data forwarding priority is mechanism to prioritize which data should be forwarded first when multiple data packets are stored and waiting to be transmitted. Priority settings can be based on factors like the importance of the data, its age, or its urgency. This helps in optimizing the performance of the network apparatus (202) and ensuring that critical data is delivered in a timely manner.

Further, the plurality of parameters of the S&F satellite operation mode is determined based on a satellite coverage availability information. The satellite coverage availability information refers to data that indicates the areas or regions where satellite signals are accessible or where satellite services can be provided. This information is crucial for various applications and services relying on satellite communication. Satellite coverage availability information is essential for determining where and how effectively satellite-based services can be provided. It helps in optimizing the use of satellite resources and ensuring reliable service delivery across different regions.

In an embodiment, the first S&F controller (808) determines the S&F support capability of the network apparatus based on a plurality of factors. For example, the plurality of factors include a location, an area, a time-slot, a time period, a time-zone, an application, a service, a feeder link availability status, a satellite coverage availability information, a UE subscription, a policy, a regulatory requirement, an operator policy, a UE type, a UE priority, a data type, a data priority, a network type, a UE usage setting, and the like.

The location refers to specific geographic point or area defined by coordinates, address, or landmarks. The area refers to defined region or zone that can encompass multiple locations. The time-slot refers to a specific interval of time allocated for a particular activity or purpose. Time-slots are used for tasks like data transmission, access to resources, or service availability. The time period refers to a duration of time with a defined start and end. The time-zone refers to a geographic region where the same standard time is used. The application may include messaging, navigation, or data analysis tools. The service refers to the specific offerings provided by the network apparatus (202), such as communication, data transfer, navigation, or broadcasting.

The feeder link availability status refers to information about whether the link between the network apparatus (202) and its ground station (feeder link) is operational or available. It is essential for ensuring that data can be effectively transmitted between the satellite and the ground network (104). The satellite coverage availability information refers to data about the geographic areas or regions where a satellite's signal or services are accessible. The UE subscription refers to a service plan or contract that UE (102) has with the network apparatus (202). It includes details on the services, data limits, and features available to the UE (102). The policies govern aspects such as data usage, access control, and service quality. The regulatory requirement ensures compliance with laws and regulations related to telecommunications, data protection, and service standards. The operator policy refers to rules and guidelines set by the network apparatus (202) for managing services, resources, and customer interactions. The UE type refers to a category or classification of the UE (102) based on its capabilities, features, or intended use.

The UE priority refers to a ranking or level of importance assigned to the UE (102) for resource allocation or service quality. It may be useful in scenarios where resources need to be allocated based on the priority level of the UE (102), such as during network congestion. The data type includes types like voice, text, video, or sensor data, and affects how the data is managed and transmitted. The data priority determines how data is prioritized for transmission, especially in scenarios with limited bandwidth or network congestion. The network type refers to classification of the network apparatus (202) based on its technology or purpose. Further, the UE usage setting refers to a configuration or preferences set on the UE (102) that determine how it uses network resources and services. It includes settings related to data usage, roaming, connectivity options, and application preferences.

In an embodiment, the first S&F controller (808) handles the S&F satellite operation mode based on the plurality of factors. Handling the S&F satellite operation mode involves managing data storage and forwarding efficiently, ensuring timely delivery and compliance with policies and regulations. Key aspects include data buffering, scheduling, prioritization, acknowledgment handling, feeder link management, and adherence to regulatory and operator policies. Effective management of these elements ensures reliable and efficient operation of satellite-based communication systems using the S&F mode.

In an embodiment, the first S&F controller (808) performs a negotiation with the UE (102) based on the plurality of factors. The negotiation enables the UE (102) and the network apparatus (202) to negotiate the capability of the S&F satellite operation, the configuration of the S&F satellite operation, and the parameters of the S&F satellite operation during the NAS signaling.

In an embodiment, the first S&F controller (808) detects whether a feeder link is not available when the network apparatus (202) supports the S&F satellite operation mode. The feeder link is a communication channel that connects a satellite (the network apparatus (202)) to the ground network (104). It is used for transmitting data, commands, and control information to and from the satellite, enabling its operation and functionality. Feeder links come in different types and operate on various frequency bands, with emphasis on reliability, bandwidth, and capacity management to ensure effective satellite communications.

In an embodiment, the first S&F controller (808) sends the SIB message and/or the NAS signaling message to the UE (102) to indicate that the S&F satellite operation is being used while the feeder connection is unavailable.

In an embodiment, the first S&F controller (808) determines whether the network apparatus currently has limited storage space. The limited storage space refers to a constrained amount of storage capacity available for data, files, or other digital content. This constraint affects how much data can be saved, managed, and processed within the satellite communication system.

In an embodiment, the first S&F controller (808) allocates one or more S&F parameters to the UE if the network apparatus has limited storage space. For example, the S&F parameters may include data storage quotas, retention period, forwarding priorities, and the like. Allocating S&F parameters to the UE (102) when the network apparatus (202) has limited storage space involves assessing storage needs, prioritizing data, and managing quotas, retention periods, and forwarding priorities. This process ensures that the limited storage is used efficiently and that critical data is handled appropriately. Effective allocation and management strategies are crucial for maintaining operational efficiency and meeting data handling requirements in a constrained storage environment.

In an embodiment, the first S&F controller (808) determines one or more services that are supported and one or more services that are restricted by the UE (102) and the network apparatus (202) when the network apparatus (202) operates in the S&F satellite operation mode. For instance, the services supported in the S&F satellite operation mode may include, but not limited to data storage, message forwarding, basic communication services (SMS, email), and the like. The services that are restricted or not supported in the S&F satellite operation mode may include, but not limited to real-time communication, instant messaging, high-bandwidth application, and the like.

In an embodiment, the first S&F controller (808) determines one or more geographical areas where the network apparatus (202) is connected to the ground network (104) via the feeder link. The geographical areas are determined by factors such as the satellite's orbital position, antenna design, and frequency bands. Effective management of these coverage areas ensures reliable data transmission and operational efficiency for satellite communications.

In an embodiment, the first S&F controller (808) retains the network apparatus (202) in the S&F satellite operation mode when the network apparatus (202) cannot connect to the ground network (104) via the feeder link. Else, the first S&F controller (808) switches the network apparatus (202) to the normal mode or default mode, or retains the network apparatus (202) in the S&F satellite operation mode when the network apparatus (202) is connected to the ground network (104) via the feeder link.

In an embodiment, the first S&F controller (808) determines a data forward priority based on a priority of the network apparatus (202), a priority of the data, and a priority of the UE (102). The data forward priority refers to the precedence of data transmission from the network apparatus (202) to the ground network (104). Data with a higher priority will be forwarded before lower-priority data, ensuring that urgent or critical data is transmitted promptly when transmission opportunities arise. Prioritization is based on factors like service type, data type, UE subscription level, and regulatory policies, and ensures that critical data is transmitted promptly, especially when satellite resources like storage space and transmission opportunities are limited.

In an embodiment, the first S&F controller (808) transmits the stored data based on the data forward priority to the ground network (104) and/or the UE (102).

In an embodiment, the first S&F controller (808) determines whether a S&F data storage quota of the UE (102) has been exhausted. The S&F data storage quota refers to a limit on the volume of data that can be buffered or stored on the network apparatus (202) for a particular UE (102). The quota helps optimize a storage capacity, ensuring that resources are efficiently managed and that all UEs have fair access to storage, especially in constrained environments. Once the quota is reached, the network apparatus (202) may either stop accepting new data from the UE (102) or overwrite existing data.

In an embodiment, the first S&F controller (808) discards the data/signaling of the UE (102) when the S&F data storage quota of the UE (102) is exhausted. Upon successful discard, an indication message is transmitted to the UE (102). The indication message indicates that the stored data/signaling has been discarded when the S&F data storage quota of the UE (102) is exhausted.

In an embodiment, the first S&F controller (808) discards the data/signaling of the UE (102) when the S&F data retention period of the UE (102) is exhausted/expired. Upon successful discard, an indication message is transmitted to the UE (102). The indication message indicates that the stored data/signaling has been discarded when the S&F data retention period of the UE (102) is exhausted/expired.

In an embodiment, the first S&F controller (808) determines whether the UE has subscribed for a S&F capability by using UE subscription information. The UE subscription information refers to the set of details and data that define service entitlements, privileges, and configurations associated with the UE (102). This information is critical for determining what services and resources the UE (102) can access and under what conditions. For instance, the UE subscription information includes the S&F data storage quota of the UE (102), the S&F data retention period of the UE (102), the S&F data forwarding priority of the UE (102), the S&F support capability of the UE (102), and the like.

In an embodiment, the first S&F controller (808) stores the S&F support capability of the UE (102) and/or S&F parameters (e.g. the S&F data storage quota of the UE (102), the S&F data retention period of the UE (102), the S&F data forwarding priority of the UE (102)) as part of the UE subscription information in a home subscriber server (HSS) or a UDM.

In an embodiment, the first S&F controller (808) receives/retrieves the UE subscription information from a home subscriber server (HSS) or a UDM. The HSS or UDM is responsible for managing subscriber information, handling user authentication, and supporting mobility and service authorization. It plays a key role in ensuring that subscribers can access the correct services and maintain connectivity. The HSS interacts with other core network components, such as the MME and PCRF, using protocols like diameter, and supports features like roaming and QoS management.

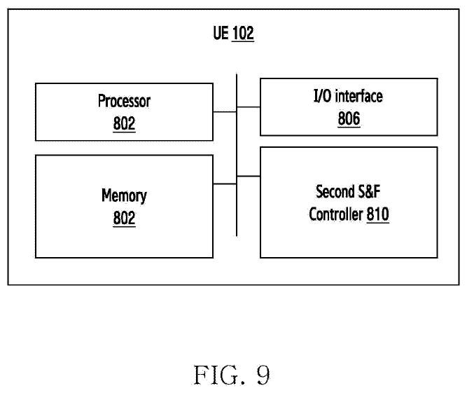

FIG. 9 is a block diagram that illustrates a schematic of the UE (102) implemented to carry out the disclosed subject matter according to an embodiment of the disclosure.

Referring to FIG. 9, as shown, the UE (102) includes the processor (802), the memory (804), the I/O interface (806), and a second S&F controller (810). The second S&F controller (810) communicates with the I/O interface (806) and the memory (804). The second S&F controller (810) may be communicatively coupled to the memory (804) and the processor (802). The second S&F controller (810) is an innovative hardware that is realized through the physical implementation of both analog and digital circuits, including logic gates, integrated circuits, microprocessors, microcontrollers, memory circuits, passive and active electronic components, as well as optical components.

In an embodiment, the second S&F controller (810) detects whether the UE (102) is in a satellite coverage with the network apparatus (202) and whether the UE (102) supports a S&F satellite operation mode. The satellite coverage refers to the geographical area on Earth where a satellite can provide its services, such as communication, broadcasting, or observation. This area is also known as the satellite's footprint. The extent and quality of satellite coverage depend on several factors, including the satellite's orbit, antenna design, and the type of service it offers.

In an embodiment, the second S&F controller (810) receives an SIB message from the network apparatus (202) when the network apparatus (202) operates in the S&F satellite operation mode. For instance, the SIB message may include a SIB31 message, a SIB32 message, a SIB19 message, an existing SIB message, a new SIB message, and the like. The SIB message contains scheduling information, which informs the UE (102) when other types of system information will be communicated, as well as synchronization information, which allows the UE (102) to coordinate its timing with the network apparatus (202).

In an embodiment, the second S&F controller (810) receives a NAS signaling message from the network apparatus (202) when the network apparatus (202) operates in the S&F satellite operation mode. For example, the NAS signaling message includes, but not limited to an attach accept message, an attach reject message, a tracking area update (TAU) accept message, a TAU reject message, a service accept message, a service reject message, a registration accept message, a registration reject message, an authentication result message, an authentication reject message, a detach accept message, a deregistration accept message, a UE configuration update command (UCU) message, a UE parameters update command (UPU) message, a UE capability enquiry message, PDU session establishment accept, PDU session establishment reject, PDN Connectivity Accept, PDN Connectivity Reject, an existing NAS signaling message, a new NAS signaling message, and the like.

In an embodiment, the second S&F controller (810) generates a first NAS signaling message to be transmitted to the network apparatus (202) when the UE (102) is in the satellite coverage and supports the S&F satellite operation mode. For instance, the first NAS signaling message includes a S&F feature supported flag signaling an ability of the UE to handle S&F operations, an expected S&F data storage quota of the UE, a S&F data retention period, a S&F data forwarding priority, and the like.

In an embodiment, the second S&F controller (810) receives a second NAS signaling message from the network apparatus upon reception of the first NAS signaling message. For instance, the second NAS signaling message may include a S&F support capability of the network apparatus (202), a S&F data retention period of the network apparatus (202), a determined S&F data storage quote of the network apparatus (202), and the like.

In an embodiment, the second S&F controller (810) determines whether the UE (102) has subscribed for a S&F capability by using UE subscription information for a S&F capability. The UE subscription information includes a S&F data storage quota, a S&F data retention period, a S&F data forwarding priority, and a S&F support capability of the UE (102). The UE subscription information describes a service plan or contract that UE (102) has with the network apparatus (202). It offers information about the services, data restrictions, and features accessible to the UE (102). The policies regulate data usage, access control, and service quality. The regulatory requirement assures adherence to telecommunications rules and regulations, as well as data protection and service requirements. The operator policy refers to the rules and procedures established by the network apparatus (202) for managing services, resources, and customer contacts.

In an embodiment, the second S&F controller (810) determines a S&F support capability of the UE (102) based on the first NAS signaling message and a plurality of factors. For instance, the plurality of factors may include a location, an area, a time-slot, a time period, a time-zone, an application, a service, a feeder link availability status, a satellite coverage availability information, a UE subscription, a policy, a regulatory requirement, an operator policy, a UE type, a UE priority, a data type, a data priority, a network type, a UE usage setting, and the like.

In an embodiment, the second S&F controller (810) determines whether to access the network apparatus (202) that supports the S&F satellite operation mode or access one or more other networks that do not support the S&F satellite operation mode. This determination is based on one or more policies associated with the UE (102). Determining whether to access a satellite that supports the S&F satellite operation mode is a policy-driven decision based on the UE's subscription, network conditions, regulatory requirements, and service type. The second S&F controller (810) evaluates these policies dynamically, considering factors like geographical location, service priority, and storage quota. The decision to grant or deny access ensures that satellite resources are allocated efficiently and in alignment with the service entitlements of the UE (102) and network policies.

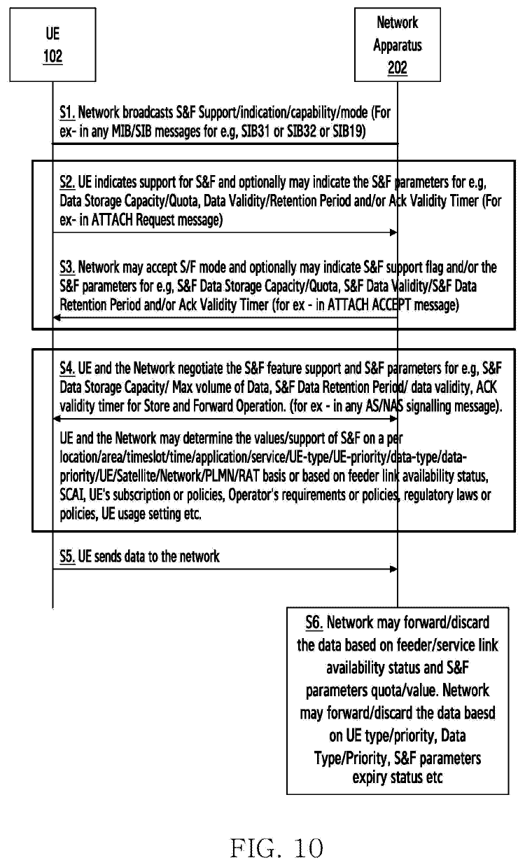

FIG. 10 is a sequence diagram that illustrates handling the S&F satellite operation for satellite communication according to an embodiment of the disclosure.

Referring to FIG. 10, as shown in the sequence diagram, the UE (102) is in communication with the network apparatus (202). Each operation of the sequence diagram is explained in further detail below. The operations can occur in any order or combination.

At operation S1, the network apparatus (202) broadcasts S&F support/indication/capability/mode to the UE (102) by using any broadcast messaging or IEs in the broadcast messages or NAS signaling messages. Some broadcast messages, for example, may be SIB, master information block (MIB), SIB31, SIB32, SIB19, or any other broadcast message. The network apparatus (202) can use the existing IE(s) or any new IE (for example, S&F mode/capability/Support) to indicate the support of the S&F mode/operation. The values of IE(s) can indicate whether the S&F mode is supported (for example, Value=1 or True) or not supported (for example, Value=0 or False). Further, some of the AS/NAS signaling messages/procedures include attach accept message or attach procedure, UE capability enquiry message or UE network capability exchange/negotiation procedure, registration accept message or registration procedure, TAU Accept message or TAU procedure, UE UCU command message/procedure, and UE UPU command message/procedure. For instance, the network apparatus (202) can signal or include a bit/IE/feature flag to indicate its capacity for S&F.

At operation S2, the UE (102) indicates its support for S&F mode/capability or whether it has activated S&F Satellite operation mode. The UE (102) can indicate its S&F mode/capability/support using any of the signaling messages or AS/NAS signaling messages/procedures, such as the attach request message or attach procedure, the UE capability information message or UE Network capability information exchange/negotiation procedure, the registration request message or registration procedure, the TAU request message or TAU procedure, and so on. The UE (102) can signal or contain a bit/IE/feature flag to indicate its support for S&F.

At operation S3, the network apparatus (202) may accept the S/F mode and optionally signal the S&F support flag and/or the S&F parameters, such as S&F data storage capacity/quota, S&F data validity/retention duration, using any dedicated signaling messages or Access Stratum (AS) or Non-Access Stratum (NAS) signaling messages (for example, in an ATTACH ACCEPT message). Further, some of the AS/NAS signaling messages/procedures include attach accept message or attach procedure, UE capability enquiry message or UE network capability exchange/negotiation procedure, registration accept message or registration procedure, TAU Accept message or TAU procedure, UE UCU command message/procedure, and UE UPU command message/procedure. For instance, the network apparatus (202) can signal or include a bit/IE/feature flag to indicate its capacity for S&F.

At operation S4, the UE (102) and the network apparatus (202) negotiate the S&F parameters (for example, S&F data storage quota, S&F data retention duration, Validity Timer, etc.), their values, and configuration in the AS/NAS signaling messages/procedures, for example. Attach Accept message or Attach Procedure, UE capability Enquiry Message or UE Network capability exchange/negotiation procedure, Registration Accept Message or Registration Procedure, Tracking Area Update (TAU) Accept message or TAU procedure, UE Configuration Update (UCU) Command message/Procedure, UE Parameters Update (UPU) Command message/Procedure, and the like. At operation S5, the UE (102) sends the data to the network apparatus (202).

In an embodiment, the Network includes or the UE includes or the UE and the Network negotiate the S&F parameters (e.g. S&F data storage quota, S&F data retention period or Validity Timer etc.), its values and configuration in the AS/NAS signaling messages/procedures for e.g. can be Attach Accept message or Attach Procedure, UE capability Enquiry Message or UE Network capability exchange/negotiation procedure, Registration Accept Message or Registration Procedure, Tracking Area Update (TAU) Accept message or TAU procedure, UE Configuration Update (UCU) Command message/Procedure, UE Parameters Update (UPU) Command message/Procedure etc.

In an embodiment, the UE (102) or the network apparatus (202) determine the values/configuration of the S&F support and the S&F parameters using one or more of the below parameters, in any order or combination:

Per location/Area basis: The Network and/or the UE may support/indicate S&F mode/operation at certain location/area and when the location/area of the UE/Satellite is changed, the S&F mode/operation/support may change.

Per time/time-zone/time-slot basis: The Network and/or the UE may operate in S&F mode at certain times and at other times, the Network or the UE may not support S&F mode.

Per Application/Service basis: The Network and/or the UE may support/indicate S&F mode/operations only for certain services/applications (e.g. SMS service, other delay tolerant service) and may not support S&F mode/operation for other services/applications (e.g. Voice services/Data services etc.).

Based on Feeder link availability status: The Network and/or the UE may support/indicate S&F mode/operation only when Feeder Link is unavailable (e.g. there is no connection between the Satellite Network and the Ground Network) and may not indicate/support S&F mode/operation when Feeder link is available.

Based on Satellite Coverage Availability Information (SCAI): The Network and/or the UE may determine the values of the S&F support or the S&F parameters based on the SCAI and satellite coverage time/map.

Based on UE subscription/policy: The Network and/or the UE may determine or store the values of the S&F support for the UE from/in the UE's subscription or policy. The Network may determine whether to allow/accept the UE to operate in S&F mode based on UE's subscription or policy. The UE may determine whether it can operate in or switch to S&F mode based on its UE's policy or subscription. The Network may pre-configure or pre-configure the S&F support/mode in the UE (e.g. in ME/USIM).

Based on Operator's policies and regulatory requirements: The Network and/or the UE may determine whether it can operate in S&F mode based on operator's policies and local policies or regulatory rules and laws/requirements.

Per UE or per Satellite or per PLMN/RAT basis: The network apparatus (202) and/or the UE (102) may support/indicate S&F mode/operation on a per-UE/Satellite/Network (e.g., per PLMN, RAT, Cell, or any Network identification) basis. The network apparatus (202) may allow S&F mode for one or more UE(s), but not for others at the same time or location. The UE (102) may support S&F mode/operation for some networks/PLMNs but not for others.

Per UE type or per Data Type: The network apparatus (202) and/or the UE (102) may determine the values of the S&F support or the S&F parameters based on the type of the UE(s) (for example, delay-tolerant UE, non-delay tolerant UE) (for example, IOT device, smartphones, tablets, watches, etc.) or the type of data being communicated/signaled (for example, voice signals, data signals, emergency data, non-emergency data, etc.). For example, delay-tolerant devices or IOT devices may have S&F support from the UE/Network side, but other devices may not.

Based on UE/Data Priority: The network apparatus (202) and/or the UE (102) may use the UE/Data priority to determine the values of the S&F support or S&F parameters. Higher priority UE(s) (for example, User Critical devices, Priority Users) or Higher Priority Data (for example, emergency data, etc.) may support S&F mode/operation and have better/higher values of S&F parameters, whereas Low Priority UE(s)/Data may not support S&F mode/operation or have lower values of S&F parameters.

Based on UE Usage setting: The network apparatus (202) and/or the UE (102) may support/indicate S&F mode/operation based on the UE Usage Setting (such as Voice Centric UE or Data Centric UE). The network apparatus (202) or the UE (102) may not support/indicate S&F support for a Voice Centric UE, or the network apparatus (202)/UE (102) may change the UE Usage Setting for a Voice Centric UE to Data Centric UE in order to indicate/support S&F mode/operations. The network apparatus (202) and/or the UE (102) may support S&F mode for a data-centric UE.

At operation S6, the network apparatus (202) may forward/discard the data/signaling based on feeder/service link availability status and S&F parameters quota/value. The network apparatus (202) may forward/discard the data/signaling based on UE type/priority, Data Type/Priority, S&F parameters expiry status, and the like.

In an embodiment, the network apparatus (202) may handle the data/signaling from the UE (102) based on S&F parameters value and may forward/transmit/discard the data/signaling to other network entities/to the ground network (104)/to the UE (102) based on the Feeder Link/Service Link availability status and the S&F parameters value. For example, if the S&F Data Storage Quota, or S&F Data Retention period, or Data Validity timer are exceeded or exhausted, the network apparatus (202) may delete the stored data/signaling. When the data/signaling is stored on the network apparatus (202) (for example, satellite), the network apparatus (202) may forward the data/signaling to the next destination (for example, MO data to the ground network (104) or MT data back to the UE (102)) if the feeder link or service link is available.

In an embodiment, the network apparatus (202) may decide the data forward priority of the data/signaling (for example, to the ground network (104) or to the UE (102)) based on the priority of the Data/UE (for example, Critical/Priority Data or the Data from the Priority UE(s)/User(s) may be forwarded first), based on the S&F parameters expiry (for example, the data/UE for which the S&F Data Storage quota, the S&F Data Retention Period, or the Data Validity timer is over/exhausted/about to expire, may be forwarded first). Based on the kind of data (for example, DL data may be transmitted first before UL data, or data from specific apps may be forwarded first, etc.) and other considerations.

In an embodiment, the network apparatus (202) may decide to discard the data/signaling for which the S&F parameters values have expired/exhausted/over or when the network apparatus (202) is congested or when the satellite storage quota is over/exhausted based on the priority of the Data/UE (for example, Non-Critical/Non-Priority Data or the Data from the Priority UE(s)/User(s) may be discarded first), based on the S&F parameters expiry (for example, the data/UE for which the S&F Data Storage quota or the S&F Data Retention Period or the Data Validity timer is over/exhausted/about to expire, may be discarded first), based on the type of the Data (for example, DL data may be discarded first or Data from certain applications may be discarded first, etc.) and other such factors.

In an embodiment, The Network/Satellite can indicate its support for S/F mechanism (e.g. S&F Support or S&F capability), max volume of Data (e.g. S&F Data storage quota), data validity (e.g. S&F Data Retention period) to the UE in Attach accept or any other AS or NAS message. Max volume of Data, data validity can be for overall satellite/UE basis, per UE basis, per location basis, per satellite basis or any combination of these. Max volume of Data, data validity can be indicated to/from the UE via Application Server, through Pre-Configuration, during signaling exchange such as Registration/Attach Procedure or UCU/UPU command or any AS/NAS signaling message etc. with AMF/MME or any Network Functions like SMF, UPF etc. Max volume of Data, data validity values can be negotiated based on subscription or local operator policy/configuration/location or priority of data or UE priority.

In an embodiment, the UE can be indicated based on subscription or local operator policy/configuration/location if it can use S/F mechanism if available or the location where it can use S/F or the volume of data it can send or receive or/and the type of data it can send or receive in S/F. The UE can be indicated about these in Reconfiguration message or Attach Accept or UE Parameter Update or UE Configuration Update or during Registration/Attach Procedure (e.g. Registration Accept message or Attack Accept Message) or TAU/MRU procedure or any other NAS or AS signaling message. The network can indicate/assign the UE a longer time period/more time duration or better validity of the data based or a larger volume for S/F based on the. Based on these UE can be allowed or restricted from using S/F mechanism or the location where it can use S/F mechanism or the volume of data it can send or receive or/and the type of data it can send or receive in S/F mode.

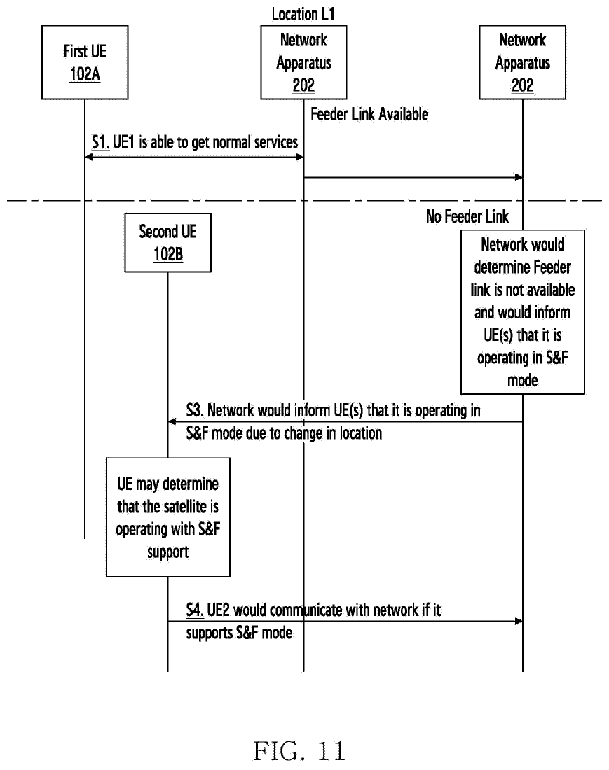

FIG. 11 is a sequence diagram that illustrates switching between normal mode to S&F mode based on location according to an embodiment of the disclosure.

Referring to FIG. 11, as shown in the sequence diagram, the first UE (102A) and the second UE (102B) are in communication with the network apparatus (202) at location L1 and location L2. At operation S1 (at time T1), the first UE (102A) is able to get normal services and informs the network apparatus (202) at location L1 regarding the same. At operation S2, the network apparatus (202) at location L1 moves to location L2. At operation S3 (at time T2), network apparatus (202) informs the second UE (102B) that it is operating in S&F mode due to change in location. At operation S4, the second UE (102B) communicates with the network apparatus (202) if it supports S&F mode.

The network apparatus (202) would identify that the feeder connection is unavailable (for example, based on Satellite Coverage Availability information) and notify the second UE (102B) that it is operating in S&F mode (for example, owing to a change in location). The presence of a second UE (102B) at the location may indicate that the network apparatus (202) is functioning in the S&F mode. If the network apparatus (202) supports S&F mode, the second UE (102B) will interact with it and get the required/supported services.

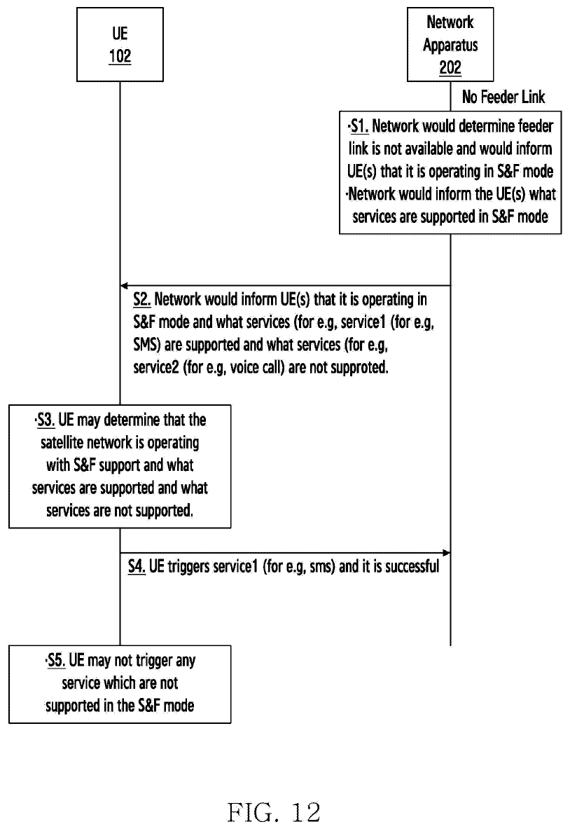

FIG. 12 is a sequence diagram that illustrates indication of supported services in S&F mode according to an embodiment of the disclosure.

Referring to FIG. 12, as shown in the sequence diagram, the UE (102) is in communication with the network apparatus (202).

At operation S1, the network apparatus (202) would determine that a feeder link is not available and would inform the UE (102) that it is operating in S&F mode. The network apparatus (202) would inform the UE (102) what services are supported in S&F mode and what services are restricted in S&F mode. At operation S2, the network apparatus (202) would inform the UE (102) that it is operating in S&F mode and what services (for example, SMS) are supported and what services (for example, voice call) are not supported/restricted. At operation S3, the UE (102) may determine that the network apparatus (202) is operating with S&F support and what services are supported and what services are not supported. At operation S4, the UE (102) triggers service1 (for example, SMS) and it is successful. At operation S5, the UE (102) may not trigger any service which are not supported in the S&F mode.

The network apparatus (202) would determine that the feeder link is not available (for example, based on Satellite Coverage Availability information) and would notify the UE (102) that it is operating in S&F mode, as well as which services/applications are supported and which are not or are limited. The UE (102) present at the site may detect that the network apparatus (202) is operating in S&F mode and what services are supported (for example, SMS) as well as service restrictions/limitations in S&F mode. The UE (102) would communicate with the network apparatus (202) if it supports the S&F mode and receives required/supported services in S&F mode.

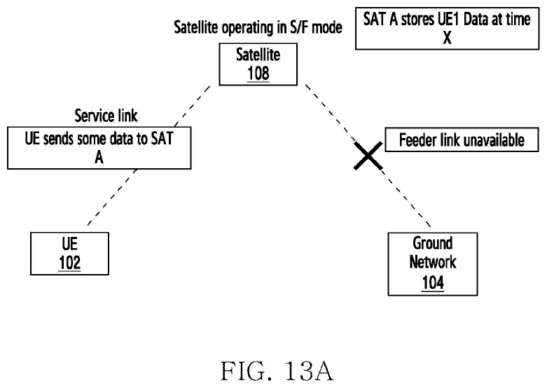

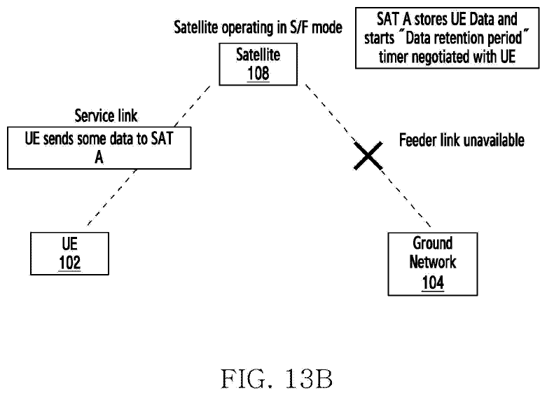

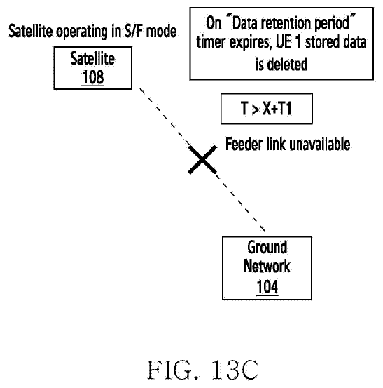

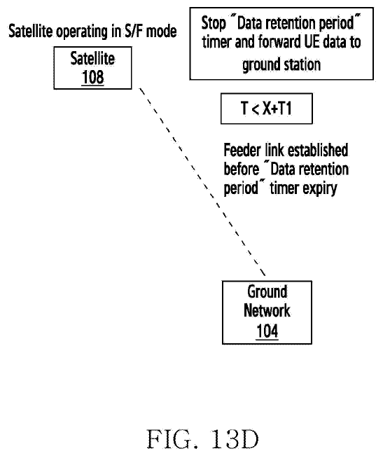

FIGS. 13A, 13B, 13C, and 13D are block diagrams that illustrate handling of the S&F data retention period according to various embodiments of the disclosure.

Referring to FIGS. 13A to 13D, before the UE (102) sends data/signaling to the satellite (108), the UE (102) and the network apparatus (202) agree on the period (Data retention period) during which the satellite (108) or S/F server can store the UE (102) sent data/signaling based on subscription or/and local operator policy/configuration/location/UE-priority or Data-Priority.

If the feeder connection, target UE, or Inter-Satellite connection (ISL) to another SAT are still inaccessible at the end of this period (data retention period), the satellite (108) or S/F server shall remove the stored data supplied by the UE (102). Before the expiry of this period (data retention period) timer, if feeder link becomes available or/and target UE is available or/and IS link to other SAT becomes available, then this period (data retention period) timer should be stopped and the UE (102) data should be forwarded/delivered to the ground network (104) or/and target UE or/and other available SAT (for example, based on the UE (102) or data priority/criticality or other factors as described in the proposed solution).

Based on the feeder link/service link availability status and the S&F parameters value, the network apparatus (202) may handle the data from the UE (102) and forward/transmit/discard it to other network entities/the ground network (104)/the UE (102). For example, if the S&F data retention period or validity timer expires, the network apparatus (202) may delete the stored data. When the network apparatus (202) (for example, satellite) stores the data, it may forward the data to the next destination (for example, MO data to the ground network (104) or MT data back to the UE (102)) when the feeder link or service link is available.

The network apparatus (202) may determine the data forward priority (for example, to the ground network (104) or to the UE (102)) depending on the data/UE's priority. For example, critical/priority data or data from priority UE(s)/User(s) may be forwarded first), based on the expiry of S&F parameters (for example, data/UE for which the S&F data storage quota, the S&F data retention period, or the data validity timer is over/exhausted/about to expire), based on the type of data, and other such factors.

The network apparatus (202) may opt to reject data for which the S&F parameter values have expired/exhausted/exceeded, when the network apparatus (202) is crowded, or when the satellite storage quota is over/exhausted depending on the Data/UE's priority. For example, non-critical/non-priority data or data from the priority UE(s)/User(s) may be discarded first, based on the expiry of the S&F parameters (for example, the data/UE for which the S&F data storage quota, the S&F data retention period, or the data validity timer is over/exhausted/about to expire), based on the type of the data (for example, DL data may be discarded first or data from certain applications may be discarded first), and other such factors.

In an embodiment, the solutions explained in this embodiment are illustrated with data as an example. However, the similar solutions are applicable for data, signaling or any parameters/messages/procedures/signaling exchange between UE (102) and the Network apparatus (202).

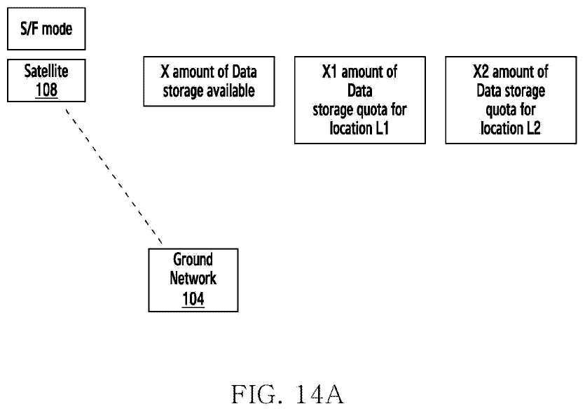

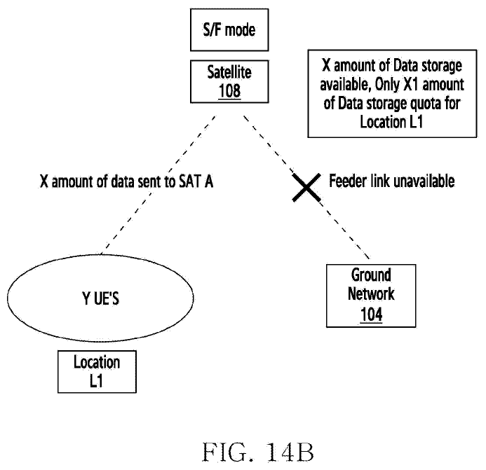

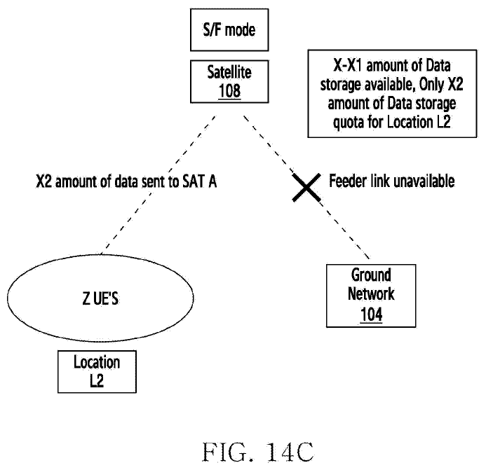

FIG. 14 A, 14B, and 14C are block diagrams that illustrate handling of the S&F data storage quota according to various embodiments of the disclosure.

Referring to FIGS. 14A to 14C, the satellite (108) has no feeder link available and is operating in S&F mode at position L1, with X volume of data space available. At Location L1, Y number of UEs are present, each of which supports the S&F mechanism and is permitted by the ground network (104) at location L1. The ground network (104) should be set per location per satellite data storage allowance, in addition to per UE. Site-based data storage quotas can be negotiated depending on the number of UEs expected to be present per site, the period after which the feeder connection will be accessible, the duration for which the satellite (108) will be present at a certain position, or on a subscription basis (remote research area).

Based on the location-based data storage quota, the satellite (108) or the network apparatus (202) (AMF, MME, or any other network entity) might limit the per-UE per-satellite data storage quota to UEs based on priority, subscription, or operator policy at a specific place. The location-based data storage quota ensures that the satellite (108) has enough data storage capacity for each location.

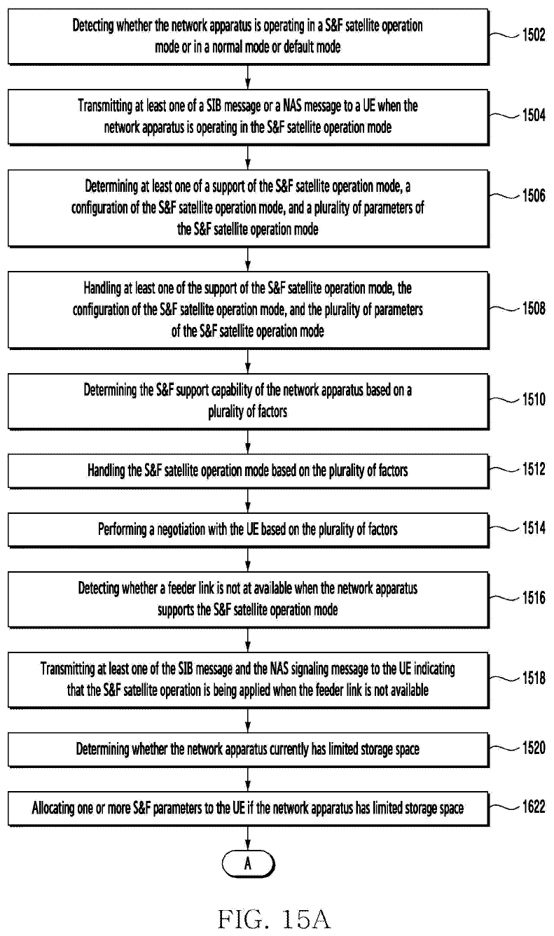

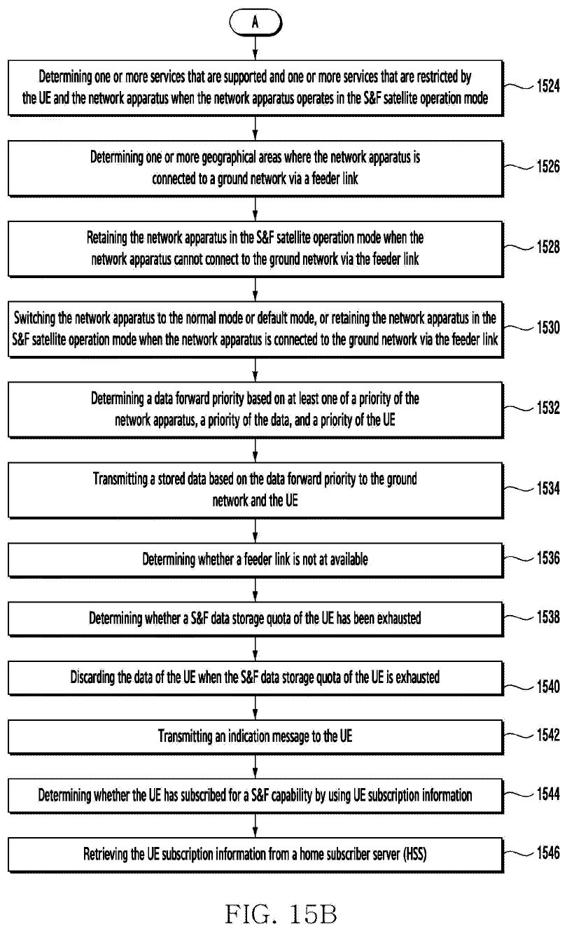

FIGS. 15A and 15B are flowcharts that illustrate a method for handling a store and forward (S&F) satellite operation for satellite communication by the network apparatus (202) according to various embodiments of the disclosure. The method includes operations 1502 to 1546. Each operation is explained in further detail below.

Referring to FIGS. 15A and 15B, at operation 1502, the network apparatus (202) detects whether the network apparatus (202) is operating in a store & forward (S&F) satellite operation mode or in a normal mode or default mode. In the S&F satellite operation mode, the satellite briefly stores received data onboard before forwarding it to the target ground station once it is within range. This is especially beneficial for communication between two locations that may not have simultaneous access to the satellite. When the satellite flies over the ground network (104) it collects data and saves it in its onboard memory. When the satellite enters range of the destination ground network (104), it transmits the stored data to it. In normal mode, or default mode, the satellite is fully operational and capable of performing its assigned activities, such as communication, photography, or scientific observations.

At operation 1504, the network apparatus (202) transmits a system information broadcasting system information block (SIB) message or a MIB message to the UE (102) when the network apparatus (202) is operating in the S&F satellite operation mode. For instance, the MIB message or the SIB message may be a SIB31 message, a SIB32 message, a SIB19 message, an existing SIB message, a new SIB message, and the like. The MIB or the SIB message contains scheduling information, which informs the UE (102) when other types of system information will be communicated, as well as synchronization information, which allows the UE (102) to coordinate its timing with the network apparatus (202). The SIB31 message broadcasts information about the availability of surrounding networks to help UEs that enable dual connectivity (LTE and CDMA2000). The SIB32 message aids in managing smooth transitions between the UE (102) and the network apparatus (202), guaranteeing service continuity while moving between locations with varying coverage. The SIB19 message guarantees that UEs in impacted regions get vital safety information on a timely basis. The new SIB messages are introduced in newer network standard releases to support enhanced or new network capabilities.

Further, the network apparatus (202) transmits a non-access stratum (NAS) signaling message to the UE (102) when the network apparatus (202) is operating in the S&F satellite operation mode. For example, the NAS signaling message includes, but not limited to an attach accept message, an attach reject message, a tracking area update (TAU) accept message, a TAU reject message, a service accept message, a service reject message, a registration accept message, a registration reject message, an authentication result message, an authentication reject message, a detach accept message, a deregistration accept message, a UE configuration update command (UCU) message, a UE parameters update command (UPU) message, a UE capability enquiry message, PDU session establishment accept, PDU session establishment reject, PDN Connectivity Accept, PDN Connectivity Reject, an existing NAS signaling message, a new NAS signaling message, and the like.

The network apparatus (202) sends the attach accept message to the UE (102) during the attach operation to indicate that the UE (102) has successfully attached to the network apparatus (202). The network apparatus (202) sends an attach reject message to the UE (102) to deny the attach request. The attached reject message has a cause code that specifies the reason for rejection (for example, authentication failure, unlawful UE, etc.). The network apparatus (202) sends the TAU accept message to the UE (102) to confirm the TAU request. The TAU accept message indicates that the TAU was successful and may include a new tracking area list (TAL) and an updated location. The TAU reject message is issued by the network apparatus (202) in response to the TAU request. The TAU reject message includes a reason code that describes the rejection (for example, UE not permitted, unknown tracking area, etc.).

The network apparatus (202) sends the service accept message to the UE (102) to indicate that a requested service (such as voice or data) can be supplied. The network apparatus (202) sends the service reject message to the UE (102) to deny a requested service. The service reject message provides a reason code that specifies why the service request was denied (for example, service not permitted, congestion, etc.). The network apparatus (202) sends the registration accept message to confirm that the UE (102) registration operation was completed successfully. The network apparatus (202) sends the registration reject message to cancel the registration process.

The registration reject message contains a cause code that specifies the reason for rejection (for example, unauthorized, unknown network). The network apparatus (202) sends the authentication result message following the successful authentication of the UE (102). The authentication result message validates that the authentication was successful and may provide security context information for encryption and integrity protection. The network apparatus (202) sends the authentication reject message when authentication fails. The authentication reject message includes a reason number that indicates why authentication was denied (for example, wrong credentials, unlawful UE, etc.).

The UE (102) sends a detach accept message to certify that it has successfully disengaged from the network apparatus (202). The UE (102) sends the deregistration accept message to indicate the successful deregistration from the network apparatus (202). The network apparatus (202) sends the UCU message to the UE (102) to change its configuration parameters. The UCU message contains updates on network settings such as frequency, mobility parameters, and radio access setups. The network apparatus (202) sends the UPU message to update particular parameters associated with the UE (102).

The network apparatus (202) sends the UE capability enquiry message to seek information about the UE's capabilities, such as supported frequency bands, carrier aggregation, data rates, and so on. The present NAS signaling messages are those stated in the existing LTE/5G standards and are utilized for mobility management, session management, and security purposes. Furthermore, the new NAS signaling message refers to a signaling message added to updated standards to accommodate new network features or capabilities.

At operation 1506, the network apparatus (202) determines a support of the S&F satellite operation mode, a configuration of the S&F satellite operation mode, and a plurality of parameters of the S&F satellite operation mode. The support of the S&F satellite operation mode is indicated by an existing information element (IE), a new IE, an existing capability, a new capability, an existing parameter, a new parameter, a UE capability, a UE core network capability, a UE network capability, a feature flag, a support flag, a S&F support capability, a S&F support flag, a S&F feature support flag, a S&F indication, a S&F flag, and the like.

The existing IE is predefined unit of information used in signaling messages. It is part of the standard specifications and has been established in earlier versions of network protocols. The new IE is new unit of information introduced in updated versions of network specifications or standards. New IEs may be introduced to support new features, functionalities, or enhancements in network protocols. The existing capability is capability that the network apparatus (202) or the UE (102) already support, as defined by earlier 3GPP standards or specifications. The new capability is a capability that has been introduced in newer standards or updates to the existing protocol. The existing parameter is a parameter used in network protocols that has been defined in previous versions of the standards. The new parameter is a parameter introduced in recent updates to network protocols. The UE capability is a set of features and functionalities that the UE (102) supports. The UE core network capability is capabilities of the UE (102) related to its interaction with the core network.

The UE network capability is ability of the UE (102) to interact with different types of networks and access various services. The feature flag is indicator that signifies whether a particular feature is supported or not. The feature flag is used in network protocols and configurations to enable or disable specific features based on the capabilities of the UE (102) or the network apparatus (202). The support flag is a flag that indicates whether a certain functionality or feature is supported. It whether a given capability is available in the current network or UE context. The S&F support capability indicates whether the UE (102) or the network apparatus (202) supports Store and Forward (S&F) communication methods. The S&F support flag is a specific indicator within the signaling messages that shows if S&F support is enabled or not. The S&F feature supported flag is a flag that indicates whether the UE (102) or the network apparatus (202) supports specific features of the S&F communication mode. The S&F indication is a signaling message or element indicating the use or support of S&F functionality. Further, the S&F flag is a flag used to signify the presence or absence of S&F capabilities.

The plurality of parameters of the S&F satellite operation mode includes a S&F support capability, a S&F data storage quota, a S&F data retention period, a S&F data forwarding priority, and the like. The S&F support capability indicates whether the network apparatus (202) or the UE (102) supports S&F communication functionalities. This capability is important for scenarios where data needs to be temporarily stored on a satellite or network node and then forwarded to the intended destination. It ensures that the network apparatus (202) can handle the required storage and forwarding operations. The S&F data storage quota refers to the maximum amount of data that can be stored temporarily by the network apparatus (202) or the UE (102) using S&F capabilities. The S&F data retention period is a duration for which the data can be stored by the network apparatus (202) before it is forwarded or deleted. This period is crucial for ensuring timely delivery of data and managing storage efficiently. Data retention policies help in balancing between storage capacity and the need to forward data promptly.

The S&F data forwarding priority is mechanism to prioritize which data should be forwarded first when multiple data packets are stored and waiting to be transmitted. Priority settings can be based on factors like the importance of the data, its age, or its urgency. This helps in optimizing the performance of the network apparatus (202) and ensuring that critical data is delivered in a timely manner.

Further, the plurality of parameters of the S&F satellite operating mode are calculated using satellite coverage availability information. Satellite coverage availability information refers to data that indicates which places or regions can receive satellite signals or supply satellite services. This information is critical for many applications and services that rely on satellite communication. Satellite coverage availability data is critical for evaluating where and how efficiently satellite-based services may be delivered. It aids in the efficient use of satellite resources and ensures consistent service delivery across several areas.

At operation 1508, the network apparatus (202) handles the support of the S&F satellite operation mode, the configuration of the S&F satellite operation mode, and the plurality of parameters of the S&F satellite operation mode

At operation 1510, the network apparatus (202) determines the S&F support capability of the network apparatus based on a plurality of factors. For example, the plurality of factors include a location, an area, a time-slot, a time period, a time-zone, an application, a service, a feeder link availability status, a satellite coverage availability information, a UE subscription, a policy, a regulatory requirement, an operator policy, a UE type, a UE priority, a data type, a data priority, a network type, a UE usage setting, and the like.

The term “location” refers to a specific geographic place or region as specified by coordinates, address, or landmark. The term “area” refers to a specified region or zone that may include many sites. The term “time slot” refers to a defined period of time set aside for a certain activity or purpose. Time slots are utilized to perform operations such as data transmission, resource access, and service availability. The term “time period” refers to a specific amount of time having a specified beginning and finish. The term “time zone” refers to a geographic region that uses the same standard time. The program might incorporate messaging, navigation, or data analysis features. The service refers to the specific services offered by the network apparatus (202), such as communication, data transmission, navigation, or broadcasting.

The feeder link availability status indicates whether the link between the network apparatus (202) and its ground station (feeder link) is active or available. It is critical to ensuring that data is efficiently transported between the satellite and the ground network (104). Satellite coverage availability data refers to the geographic areas or territories that may receive a satellite's signal or services. The term UE subscription refers to a service plan or contract between UE (102) and the network equipment (202). It offers information about the services, data restrictions, and features accessible to the UE (102). The policies regulate data usage, access control, and service quality. The regulatory requirement assures adherence to telecommunications rules and regulations, as well as data protection and service requirements. The operator policy refers to the rules and procedures established by the network apparatus (202) for managing services, resources, and customer contacts. The UE type denotes a categorization or classification of the UE (102) based on its capabilities, characteristics, or intended use.

The UE priority is a ranking or degree of importance given to the UE (102) for resource allocation or service quality. It might be beneficial in situations when resources need to be allocated depending on the UE's priority level (102), such as during network congestion. The data type includes speech, text, video, and sensor data, and it influences how the data is maintained and sent. Data priority governs how data is prioritized for transmission, particularly in situations with limited capacity or network congestion. The network type is the classification of the network apparatus (202) according to its technology or function. Further, the UE usage setting refers to a configuration or preferences set on the UE (102) that determine how it uses network resources and services. It includes settings related to data usage, roaming, connectivity options, and application preferences.

At operation 1512, the network apparatus (202) handles the S&F satellite operation mode based on the plurality of factors. Handling the S&F satellite operating mode entails efficiently managing data storage and forwarding, assuring timely delivery, and adhering to norms and regulations. Data buffering, scheduling, priority, acknowledgment handling, feeder link management, and compliance with regulatory and operator standards are all important considerations. The effective control of these factors guarantees that satellite-based communication systems in the S&F mode operate reliably and efficiently.

At operation 1514, the network apparatus (202) performs a negotiation with the UE (102) based on the plurality of factors. The negotiation allows the UE (102) and the network apparatus (202) to negotiate the capability, configuration, and parameters of the S&F satellite operation during the NAS signaling.

At operation 1516, the network apparatus (202) detects whether a feeder link is not available when the network apparatus (202) supports the S&F satellite operation mode. The feeder link is a communication connection that connects a satellite's network apparatus (202) to the ground network (104). It transmits data, instructions, and control information to and from the satellite, allowing it to function properly. Feeder lines come in a variety of configurations and frequency bands, with a focus on dependability, bandwidth, and capacity management to enable successful satellite communications.

At operation 1518, the network apparatus (202) transmits the SIB message and/or the NAS signaling message to the UE (102) to indicate that the S&F satellite operation is being used while the feeder connection is unavailable.

At operation 1520, the network apparatus (202) determines whether the network apparatus currently has limited storage space. The term limited storage space refers to the amount of storage capacity available for data, files, or other digital assets. This limitation limits the amount of data that can be saved, maintained, and processed inside the satellite communications system.

At operation 1522, the network apparatus (202) allocates one or more S&F parameters to the UE if the network apparatus has limited storage space. For example, the S&F parameters may include data storage quotas, retention period, forwarding priorities, and the like. Allocating S&F parameters to the UE (102) when the network apparatus (202) has limited storage capacity entails determining storage requirements, prioritizing data, and maintaining quotas, retention periods, and forwarding priorities. This method guarantees that the limited storage space is used effectively and that vital data is handled correctly. Effective allocation and management techniques are critical for ensuring operational efficiency and satisfying data handling needs in a limited storage environment.

At operation 1524, the network apparatus (202) determines one or more services that are supported and one or more services that are restricted by the UE (102) and the network apparatus (202) when the network apparatus (202) operates in the S&F satellite operation mode. For instance, the services supported in the S&F satellite operation mode may include, but not limited to data storage, message forwarding, basic communication services (SMS, email), and the like. The services that are restricted or not supported in the S&F satellite operation mode may include, but not limited to real-time communication, instant messaging, high-bandwidth application, and the like.

At operation 1526, the network apparatus (202) determines one or more geographical areas where the network apparatus (202) is connected to the ground network (104) via the feeder link. Geographic areas are governed by several criteria, including the satellite's orbital position, antenna design, and frequency bands. Effective control of these coverage regions enables consistent data transfer and operational efficiency for satellite communications.

At operation 1528, the network apparatus (202) retains the network apparatus (202) in the S&F satellite operation mode when the network apparatus (202) cannot connect to the ground network (104) via the feeder link.

At operation 1530, the network apparatus (202) is switched to the normal mode or default mode, or retained in the S&F satellite operation mode when the network apparatus (202) is connected to the ground network (104) via the feeder link.

At operation 1532, the network apparatus (202) determines a data forward priority based on a priority of the network apparatus (202), a priority of the data, and a priority of the UE (102). The data forward priority specifies the order of data transmission from the network apparatus (202) to the ground network (104). Data having a higher priority will be transferred before lower-priority data, ensuring that urgent or vital data is communicated as soon as transmission possibilities exist. Prioritization is determined by criteria such as service type, data type, UE subscription level, and regulatory restrictions, and it guarantees that vital data is transferred quickly, particularly when satellite resources like as storage space and transmission possibilities are limited.

At operation 1534, the network apparatus (202) transmits the stored data based on the data forward priority to the ground network (104) and/or the UE (102).

At operation 1536, the network apparatus (202) determines whether a feeder link is not available.

At operation 1538, the network apparatus (202) determines whether a S&F data storage quota of the UE (102) has been exhausted. The S&F data storage quota limits the amount of data that may be buffered or saved on the network apparatus (202) for a certain UE (102). The quota helps to maximize storage capacity by ensuring that resources are efficiently handled and that all UEs have equitable access to storage, particularly in restricted contexts. When the quota is achieved, the network apparatus (202) can either cease taking new data from the UE (102) or overwrite current data.

At operation 1540, the network apparatus (202) discards the data of the UE (102) when the S&F data storage quota of the UE (102) is exhausted.

At operation 1542, upon successful discharge, an indication message is transmitted to the UE (102). The indication message indicates that the stored data has been discarded when the S&F data storage quota of the UE (102) is exhausted.

At operation 1544, the network apparatus (202) determines whether the UE has subscribed for a S&F capability by using UE subscription information. The UE subscription information is a collection of facts and data that describe the service entitlements, rights, and configurations associated with the UE (102). This information is crucial for defining which services and resources the UE (102) can use and under what circumstances. For instance, the UE subscription information includes the S&F data storage quota of the UE (102), the S&F data retention period of the UE (102), the S&F data forwarding priority of the UE (102), the S&F support capability of the UE (102), and the like.

At operation 1546, the network apparatus (202) receives the UE subscription information from a home subscriber server (HSS). The HSS is in charge of maintaining subscriber information, performing user authentication, and facilitating mobility and service authorization. It is critical to ensuring that subscribers can access the appropriate services and retain connected. The HSS communicates with other core network components, such as the MME and PCRF, via protocols such as diameter, and offers functions like as roaming and QoS control.

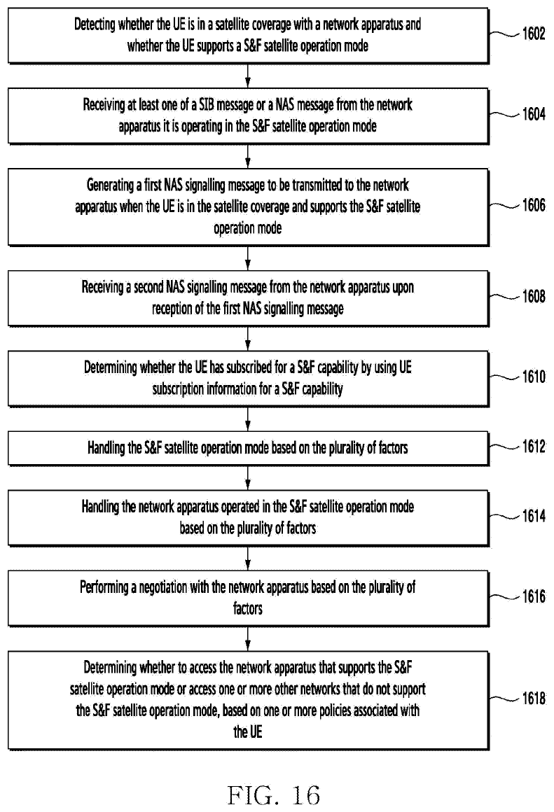

FIG. 16 is a flowchart that illustrate a method for handling a store and forward (S&F) satellite operation for satellite communication by the UE (102) according to an embodiment of the disclosure. The method includes operations 1602-1618. Each operation is explained in further detail below.

Referring to FIG. 16, at operation 1602, the UE (102) detects whether it is in a satellite coverage with the network apparatus (202) and whether the UE (102) supports a S&F satellite operation mode. Satellite coverage refers to the geographic region of Earth where a satellite may offer services such as communication, broadcasting, or observation. This region is also known as the satellite footprint. The amount and quality of satellite coverage are determined by a variety of variables, including the satellite's orbit, antenna design, and the type of service provided.

At operation 1604, the UE (102) receives an SIB message from the network apparatus (202) when the network apparatus (202) operates in the S&F satellite operation mode. For instance, the SIB message may include a SIB31 message, a SIB32 message, a SIB19 message, an existing SIB message, a new SIB message, and the like. The SIB message contains scheduling information, which informs the UE (102) when other types of system information will be communicated, as well as synchronization information, which allows the UE (102) to coordinate its timing with the network apparatus (202).

Further, the UE (102) also receives a NAS signaling message from the network apparatus (202) when the network apparatus (202) operates in the S&F satellite operation mode. For example, the NAS signaling message includes, but not limited to an attach accept message, an attach reject message, a tracking area update (TAU) accept message, a TAU reject message, a service accept message, a service reject message, a registration accept message, a registration reject message, an authentication result message, an authentication reject message, a detach accept message, a deregistration accept message, a UE configuration update command (UCU) message, a UE parameters update command (UPU) message, a UE capability enquiry message, PDU session establishment accept, PDU session establishment reject, PDN Connectivity Accept, PDN Connectivity Reject, an existing NAS signaling message, a new NAS signaling message, and the like.

At operation 1606, the UE (102) generates a first NAS signaling message to be transmitted to the network apparatus (202) when the UE (102) is in the satellite coverage and supports the S&F satellite operation mode. For instance, the first NAS signaling message includes a S&F feature supported flag signaling an ability of the UE to handle S&F operations, an expected S&F data storage quota of the UE, a S&F data retention period, a S&F data forwarding priority, and the like.

At operation 1608, the UE (102) receives a second NAS signaling message from the network apparatus upon reception of the first NAS signaling message. For instance, the second NAS signaling message may include a S&F support capability of the network apparatus (202), a S&F data retention period of the network apparatus (202), a determined S&F data storage quote of the network apparatus (202), and the like.

At operation 1610, the UE (102) determines whether it has subscribed for a S&F capability by using UE subscription information for a S&F capability. The UE subscription information includes a S&F data storage quota, a S&F data retention period, a S&F data forwarding priority, and a S&F support capability of the UE (102). The UE subscription information describes the service plan or contract between UE (102) and the network apparatus (202). It provides information on the services, data limits, and features available to the UE (102). These policies govern data usage, access control, and service quality. The regulatory requirement ensures compliance with telecommunications laws and regulations, as well as data security and service standards. The operator policy is the set of rules and procedures defined by the network apparatus (202) for managing services, resources, and customer connections.

At operation 1612, the UE (102) determines a S&F support capability based on the first NAS signaling message and a plurality of factors. For instance, the plurality of factors may include a location, an area, a time-slot, a time period, a time-zone, an application, a service, a feeder link availability status, a satellite coverage availability information, a UE subscription, a policy, a regulatory requirement, an operator policy, a UE type, a UE priority, a data type, a data priority, a network type, a UE usage setting, and the like.

At operation 1614, the UE (102) handles the network apparatus (202) operated in the S&F satellite operation mode based on the plurality of factors.

At operation 1616, the UE (102) performs a negotiation with the network apparatus (202) based on the plurality of factors. The negotiation enables the UE (102) and the network apparatus (202) to negotiate a capability of the S&F satellite operation during the NAS signaling.

At operation 1618, the UE (102) determines whether to access the network apparatus (202) that supports the S&F satellite operation mode or access one or more other networks that do not support the S&F satellite operation mode. This decision is based on one or more policies related to the UE (102). The choice to access a satellite that supports the S&F satellite operating mode is policy-driven, taking into account the UE's subscription, network circumstances, regulatory requirements, and service type. The second S&F controller (810) dynamically assesses these policies based on geographical location, service priority, and storage quota. The decision to allow or refuse access ensures that satellite resources are used efficiently and in accordance with the UE's service entitlements (102) and network regulations.

In embodiments, a method for handling a store and forward (S&F) satellite operation for satellite communication is provided. The method comprises detecting, by a network apparatus (202), whether the network apparatus (202) is operating in a S&F satellite operation mode or in a normal mode or default mode; performing, by the network apparatus (202), one of: transmitting, by the network apparatus (202), a system information block (SIB) message to a user equipment (UE) (102) when the network apparatus (202) is operating in the S&F satellite operation mode; and transmitting, by the network apparatus (202), a non-access stratum (NAS) signaling message to the UE (102) when the network apparatus (202) is operating in the S&F satellite operation mode; determining, by the network apparatus (202), at least one of a support of the S&F satellite operation mode, a configuration of the S&F satellite operation mode, and a plurality of parameters of the S&F satellite operation mode; and handling, by the network apparatus (202), at least one of the support of the S&F satellite operation mode, the configuration of the S&F satellite operation mode, and the plurality of parameters of the S&F satellite operation mode.

According to an embodiment, the network apparatus (202) is at least one of an evolved-NodeB (e-nodeB or eNB), an evolved universal terrestrial radio access network (E-UTRAN), an E-UTRAN cell, a mobility management entity (MME), a Serving Gateway (SGW), a Packet Data Network Gateway (PDN Gateway or PGW), a home subscriber server (HSS), a next generation NodeB (g-nodeB or gNB), a next generation radio access network (NG-RAN), an NG-RAN cell, an access and mobility management function (AMF), an unified data management entity (UDM), an Authentication Server Function (AUSF), a Session Management Function (SMF), an User Plane Function (UPF), a network entity, and a network function.

According to an embodiment, the network apparatus (202) is present either on-board the satellite and/or on the ground.

According to an embodiment, the SIB message comprises at least one of a SIB31 message, a SIB32 message, a SIB19 message, an existing SIB message, and a new SIB message.

According to an embodiment, the NAS signaling message transmitted by the network apparatus (202) to the UE (102) comprises at least one of an attach accept message, an attach reject message, a tracking area update (TAU) accept message, a TAU reject message, a service accept message, a service reject message, a registration accept message, a registration reject message, an authentication result message, an authentication reject message, a detach accept message, a deregistration accept message, a UE configuration update command (UCU) message, a UE parameters update command (UPU) message, a UE capability enquiry message, PDU session establishment accept, PDU session establishment reject, PDN Connectivity Accept, PDN Connectivity Reject, an existing NAS signaling message, and a new NAS signaling message.

According to an embodiment, the SIB message and the NAS signaling message comprise at least one of the support of the S&F satellite operation mode, the configuration of the S&F satellite operation mode, and the plurality of parameters of the S&F satellite operation mode.

According to an embodiment, the support of the S&F satellite operation mode is indicated by at least one of an existing information element (IE), a new IE, an existing capability, a new capability, an existing parameter, a new parameter, a UE capability, a UE core network capability, a UE network capability, a feature flag, a support flag, a S&F support capability, a S&F support flag, a S&F feature support flag, a S&F indication, and a S&F flag.

According to an embodiment, the plurality of parameters of the S&F satellite operation mode includes at least one of a S&F support capability, a S&F data storage quota, a S&F data retention period and a S&F data forwarding priority.

According to an embodiment, the plurality of parameters of the S&F satellite operation mode is determined based on a satellite coverage availability information.

According to an embodiment, the method comprises determining, by the network apparatus (202), the S&F support capability of the network apparatus (202) based on a plurality of factors; handling, by the network apparatus (202), the S&F satellite operation mode based on the plurality of factors; and performing, by the network apparatus (202), a negotiation with the UE (102) based on the plurality of factors, wherein the negotiation enables the UE (102) and the network apparatus (202) to negotiate at least one of a capability of the S&F satellite operation, a configuration of the S&F satellite operation, and the plurality of parameters of the S&F satellite operation during the NAS signaling.

According to an embodiment, the plurality of factors comprise at least one of a location, an area, a time-slot, a time period, a time-zone, an application, a service, a feeder link availability status, a satellite coverage availability information, a UE subscription, a policy, a regulatory requirement, an operator policy, a UE type, a UE priority, a data type, a data priority, a network type, and a UE usage setting.

According to an embodiment, the method comprises detecting, by the network apparatus (202), whether a feeder link is not available when the network apparatus (202) supports the S&F satellite operation mode; and transmitting, by the network apparatus (202), at least one of the SIB message and the NAS signaling message to the UE (102) indicating that the S&F satellite operation is being applied when the feeder link is not available.

According to an embodiment, the method comprises determining, by the network apparatus (202), whether the network apparatus (202) has limited storage space; and allocating, by the network apparatus (202), one or more S&F parameters to the UE (102) if the network apparatus (202) has limited storage space.

According to an embodiment, handling, by the network apparatus (202), at least one of the support of the S&F satellite operation mode, the configuration of the S&F satellite operation mode, and the plurality of parameters of the S&F satellite operation mode comprises: determining, by the network apparatus (202), one or more services that are supported and one or more services that are restricted for the UE (102) and the network apparatus (202) when the network apparatus (202) operates in the S&F satellite operation mode.

According to an embodiment, the method comprises determining, by the network apparatus (202), one or more geographical areas where the network apparatus (202) is connected to a ground network (104) via a feeder link; performing, by the network apparatus (202), at-least one of: keeping the network apparatus (202) in the S&F satellite operation mode when the network apparatus (202) cannot connect to the ground network (104) via the feeder link; and switching the network apparatus (202) to the normal mode or default mode, or keeping the network apparatus (202) in the S&F satellite operation mode when the network apparatus (202) is connected to the ground network (104) via the feeder link.

According to an embodiment, handling, by the network apparatus (202), at least one of the support of the S&F satellite operation mode, the configuration of the S&F satellite operation mode, and the plurality of parameters of the S&F satellite operation mode, further comprises determining, by the network apparatus (202), a data forward priority based on at least one of a priority of the network apparatus (202), a priority of the data, and a priority of the UE (102); performing, by the network apparatus (202), one of: transmitting, by the network apparatus (202), a stored data based on the data forward priority to the ground network (104); and transmitting, by the network apparatus (202), the stored data based on the data forward priority to the UE (102).

According to an embodiment, handling, by the network apparatus (202), at least one of the support of the S&F satellite operation mode, the configuration of the S&F satellite operation mode, and the plurality of parameters of the S&F satellite operation mode, further comprises determining, by the network apparatus (202), whether a feeder link is not available; determining, by the network apparatus (202), whether a S&F data storage quota of the UE (102) has been exhausted; discarding, by the network apparatus (202), the data of the UE (102) when the S&F data storage quota of the UE (102) is exhausted; and transmitting, by the network apparatus (202), an indication message to the UE (102), wherein the indication message indicates that the stored data has been discarded when the S&F data storage quota of the UE (102) is exhausted.

According to an embodiment, the method comprises: determining, by the network apparatus (202), whether the UE (102) has subscribed for a S&F capability by using UE subscription information, wherein the UE subscription information includes at least one of a S&F data storage quota of the UE (102), a S&F data retention period of the UE (102), a S&F data forwarding priority of the UE (102) and a S&F support capability of the UE (102); storing, by the network apparatus (202), at least one of the support of the S&F satellite operation mode, the configuration of the S&F satellite operation mode, and the plurality of parameters of the S&F satellite operation mode in the UE subscription information in at least one of a home subscriber server (HSS) and an unified data management entity (UDM); and retrieving, by the network apparatus (202), the UE subscription information from at least one of the HSS and the UDM.

In embodiments, a method for handling a store and forward (S&F) satellite operation for satellite communication is provided. The method comprises detecting, by a user equipment (UE) (102), whether the UE (102) is in a satellite coverage with a network apparatus (202) and whether the UE (102) supports a S&F satellite operation mode; and performing, by the UE (102), at least one of: receiving a system information block (SIB) message from the network apparatus (202) when the network apparatus (202) operates in the S&F satellite operation mode; and receiving a non-access stratum (NAS) signaling message from the network apparatus (202) when the network apparatus (202) operates in the S&F satellite operation mode; transmitting, by the UE (102), a first NAS signaling message to the network apparatus (202) when the UE (102) is in the satellite coverage and supports the S&F satellite operation mode; and receiving, by the UE (102), a second NAS signaling message from the network apparatus (202) upon reception of the first NAS signaling message by the network apparatus (202).

According to an embodiment, the method comprises determining, by the UE (102), whether the UE (102) has subscribed for a S&F capability by using UE subscription information for a S&F capability, wherein the UE subscription information includes at least one of a S&F data storage quota of the UE (102), a S&F data retention period of the UE (102), a S&F data forwarding priority of the UE (102) and a S&F support capability of the UE (102).

According to an embodiment, the first NAS signaling message transmitted by the UE (102) to the network apparatus (202) comprises at least one of an Attach Request message, a TAU Request message, a Service Request message, a Registration Request message, an Authentication Request message, a Detach Request message, a Deregistration Request message, an UE capability information message, PDU Session establishment request, PDN Connectivity request, an existing NAS signaling message and a new NAS signaling message.

According to an embodiment, the first NAS signaling message includes at least one of a S&F feature supported flag signaling an ability of the UE (102) to handle S&F operations, an expected S&F data storage quota of the UE (102), a S&F data retention period and a S&F data forwarding priority.

According to an embodiment, at least one of the NAS signaling message from the network apparatus (202) and the second NAS signaling message from the network apparatus (202) comprises at least one of an attach accept message, an attach reject message, a tracking area update (TAU) accept message, a TAU reject message, a service accept message, a service reject message, a registration accept message, a registration reject message, an authentication result message, an authentication reject message, a detach accept message, a deregistration accept message, a UE configuration update command (UCU) message, a UE parameters update command (UPU) message, a UE capability enquiry message, PDU session establishment accept, PDU session establishment reject, PDN Connectivity Accept, PDN Connectivity Reject, an existing NAS signaling message, and a new NAS signaling message.

According to an embodiment, at least one of the NAS signaling message from the network apparatus (202) and the second NAS signaling message includes at least one of a S&F support capability of the network apparatus (202), a S&F data retention period of the network apparatus (202), and a determined S&F data storage quote of the network apparatus (202).

According to an embodiment, the S&F data retention period is determined based on a satellite coverage availability information.

According to an embodiment, the method comprises determining, by the UE (102), a S&F support capability of the UE (102) based on the first NAS signaling message and a plurality of factors; handling, by the UE (102), the network apparatus (202) operated in the S&F satellite operation mode based on the plurality of factors; and performing, by the UE (102), a negotiation with the network apparatus (202) based on the plurality of factors, wherein the negotiation enables the UE (102) and the network apparatus (202) to negotiate a capability of the S&F satellite operation during the NAS signaling.

According to an embodiment, the method comprises the plurality of factors comprise at least one of a location, an area, a time-slot, a time period, a time-zone, an application, a service, a feeder link availability status, a satellite coverage availability information, a UE subscription, a policy, a regulatory requirement, an operator policy, a UE type, a UE priority, a data type, a data priority, a network type, and a UE usage setting.

According to an embodiment, the method comprises further comprises determining, by the UE (102), whether to access the network apparatus (202) that supports the S&F satellite operation mode or access one or more other networks that do not support the S&F satellite operation mode, based on one or more policies associated with the UE (102).

In embodiments, a network apparatus (202) for handling a store and forward (S&F) satellite operation for satellite communication, comprises memory (804); a processor (802) coupled to the memory (804); and a first S&F controller (808) communicatively coupled to the memory (804) and the processor (802), wherein the first S&F controller (808): detects whether the network apparatus (202) is operating in a S&F satellite operation mode or in a normal mode or default mode; performs at least one of: transmits a system information block (SIB) message to a user equipment (UE) (102) when the network apparatus (202) is operating in the S&F satellite operation mode; and transmits a non-access stratum (NAS) signaling message to the UE (102) when the network apparatus (202) is operating in the S&F satellite operation mode; determines at least one of a support of the S&F satellite operation mode, a configuration of the S&F satellite operation mode, and a plurality of parameters of the S&F satellite operation mode; and handles at least one of the support of the S&F satellite operation mode, the configuration of the S&F satellite operation mode, and the plurality of parameters of the S&F satellite operation mode.

In embodiments, a user equipment (UE) (102) for handling a store and forward (S&F) satellite operation for satellite communication, comprises memory (804); a processor (802) coupled to the memory (804); and a second S&F controller (810) communicatively coupled to the memory (804) and the processor (802), wherein the second S&F controller (810): detects whether the UE (102) is in a satellite coverage with a network apparatus (202) and whether the UE (102) supports a S&F satellite operation mode; performs one of receives a system information block (SIB) message from the network apparatus (202) when the network apparatus (202) operates in the S&F satellite operation mode; and receives a non-access stratum (NAS) signaling message from the network apparatus (202) when the network apparatus (202) operates in the S&F satellite operation mode; transmits a first NAS signaling message to the network apparatus (202) when the UE (102) is in the satellite coverage and supports the S&F satellite operation mode; and receives a second NAS signaling message from the network apparatus (202) upon reception of the first NAS signaling message by the network apparatus (202).

In embodiments, a method for handling a store and forward (S&F) satellite operation for satellite communication, comprises determining, by a network apparatus, whether the network apparatus is operating in a S&F satellite operation mode or not; and transmitting, by the network apparatus, at least one of a system information block (SIB) message or a non-access stratum (NAS) signaling message to a user equipment (UE) in accordance with a determination that the network apparatus is operating in the S&F satellite operation mode.

According to an embodiment, the method comprises determining, by the network apparatus, at least one of a support of the S&F satellite operation mode, a configuration of the S&F satellite operation mode, or a plurality of parameters of the S&F satellite operation mode, based on the SIB message or NAS signaling message.

According to an embodiment, the network apparatus is at least one of an evolved-NodeB (e-nodeB or eNB), an evolved universal terrestrial radio access network (E-UTRAN), an E-UTRAN cell, a mobility management entity (MME), a Serving Gateway (SGW), a Packet Data Network Gateway (PDN Gateway or PGW), a home subscriber server (HSS), a next generation NodeB (g-nodeB or gNB), a next generation radio access network (NG-RAN), an NG-RAN cell, an access and mobility management function (AMF), an unified data management entity (UDM), an Authentication Server Function (AUSF), a Session Management Function (SMF), an User Plane Function (UPF), a network entity, or a network function.

According to an embodiment, the SIB message comprises at least one of a SIB31 message, a SIB32 message, or a SIB19 message.

According to an embodiment, the NAS signaling message transmitted by the network apparatus to the UE comprises at least one of an attach accept message, an attach reject message, a tracking area update (TAU) accept message, a TAU reject message, a service accept message, a service reject message, a registration accept message, a registration reject message, an authentication result message, an authentication reject message, a detach accept message, a deregistration accept message, a UE configuration update command (UCU) message, a UE parameters update command (UPU) message, a UE capability enquiry message, PDU session establishment accept, PDU session establishment reject, PDN Connectivity Accept, PDN Connectivity Reject, an existing NAS signaling message, or a new NAS signaling message.

According to an embodiment, the SIB message or the NAS signaling message comprise at least one of the support of the S&F satellite operation mode, the configuration of the S&F satellite operation mode, or the plurality of parameters of the S&F satellite operation mode.

According to an embodiment, the plurality of parameters of the S&F satellite operation mode includes at least one of a S&F support capability, a S&F data storage quota, a S&F data retention period or a S&F data forwarding priority, and the plurality of parameters of the S&F satellite operation mode is determined based on a satellite coverage availability information.

According to an embodiment, transmitting the at least one of the SIB message or the NAS signaling message comprises determining, by the network apparatus, whether a feeder link is not available in case that the network apparatus supports the S&F satellite operation mode; and transmitting, by the network apparatus, at least one of the SIB message or the NAS signaling message to the UE indicating that the S&F satellite operation is being applied in case that the feeder link is not available.

In embodiments, a method for handling a store and forward (S&F) satellite operation for satellite communication is provided. The method comprises determining, by a user equipment (UE), whether the UE is in a satellite coverage with a network apparatus and whether the UE supports a S&F satellite operation mode or not; and in accordance with a determination that the UE is in the satellite coverage and supports the S&F satellite operation mode, receiving, from a network apparatus, a system information block (SIB) message or a non-access stratum (NAS) signaling message from the network apparatus operating in the S&F satellite operation mode.

According to an embodiment, the method comprises transmitting, by the UE, a first NAS signaling message to the network apparatus in accordance with a determination that the UE is in the satellite coverage and supports the S&F satellite operation mode; and receiving, by the UE, a second NAS signaling message from the network apparatus in response to the first NAS signaling message.

According to an embodiment, the method comprises determining, by the UE, whether the UE has subscribed for a S&F capability by using UE subscription information for a S&F capability, wherein the UE subscription information includes at least one of a S&F data storage quota of the UE, a S&F data retention period of the UE, a S&F data forwarding priority of the UE and a S&F support capability of the UE.

According to an embodiment, the first NAS signaling message transmitted by the UE to the network apparatus comprises at least one of an Attach Request message, a TAU Request message, a Service Request message, a Registration Request message, an Authentication Request message, a Detach Request message, a Deregistration Request message, an UE capability information message, PDU Session establishment request, PDN Connectivity request, an existing NAS signaling message and a new NAS signaling message.

According to an embodiment, the first NAS signaling message includes at least one of a S&F feature supported flag signaling an ability of the UE to handle S&F operations, an expected S&F data storage quota of the UE, a S&F data retention period and a S&F data forwarding priority.

In embodiments, a network apparatus for handling a store and forward (S&F) satellite operation for satellite communication is provided. The network apparatus comprises at least one processor comprising processing circuitry; and memory storing instructions that, when executed by the at least one processor, cause the network apparatus to: determine, by a network apparatus, whether the network apparatus is operating in a S&F satellite operation mode or not; and transmit, by the network apparatus, at least one of a system information block (SIB) message or a non-access stratum (NAS) signaling message to a user equipment (UE) in accordance with a determination that the network apparatus is operating in the S&F satellite operation mode.

In embodiments, a user equipment (UE) for handling a store and forward (S&F) satellite operation for satellite communication is provided. The UE comprises at least one processor comprising processing circuitry; and memory storing instructions that, when executed by the at least one processor, cause the network apparatus to determine, by a user equipment (UE), whether the UE is in a satellite coverage with a network apparatus and whether the UE supports a S&F satellite operation mode or not; and in accordance with a determination that the UE is in the satellite coverage and supports the S&F satellite operation mode, receive, from a network apparatus, a system information block (SIB) message or a non-access stratum (NAS) signaling message from the network apparatus operating in the S&F satellite operation mode.

The various actions, acts, blocks, steps, operations, or the like in the method is performed in the order presented, in a different order or simultaneously. Further, in some embodiments, some of the actions, acts, blocks, steps, operations or the like are omitted, added, modified, skipped, or the like without departing from the scope of the proposed method. The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications are intended to be comprehended within the meaning and range of equivalents of the disclosed embodiments. It is to be understood that the phraseology or terminology employed herein is for the purpose of description and not of limitation.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a network apparatus for handling a store and forward (S&F) satellite operation for satellite communication, the method comprising:
determining, by a network apparatus, whether the network apparatus is operating in a S&F mode or not;
transmitting a system information block (SIB) message to a user equipment (UE), in accordance with a determination that the network apparatus is operating in the S&F mode, the SIB message including information indicating that the network apparatus is operating in the S&F mode;
receiving a UE capability message from the UE, the UE capability message including information indicating whether the UE supports an access to the network apparatus operating in the S&F mode; and
based on the information indicates that the UE supports the access to the network apparatus operating in the S&F mode, performing a communication with the UE based on the S&F mode.

2. The method of claim 1, comprising:
determining whether the UE supports the S&F mode or not based on the SIB message.

3. The method of claim 1, wherein the network apparatus is at least one of an evolved-NodeB (e-nodeB or eNB), an evolved universal terrestrial radio access network (E-UTRAN), an E-UTRAN cell, a mobility management entity (MME), a Serving Gateway (SGW), a Packet Data Network Gateway (PDN Gateway or PGW), a home subscriber server (HSS), a next generation NodeB (g-nodeB or gNB), a next generation radio access network (NG-RAN), an NG-RAN cell, an access and mobility management function (AMF), an unified data management entity (UDM), an Authentication Server Function (AUSF), a Session Management Function (SMF), an User Plane Function (UPF), a network entity, or a network function.

4. The method of claim 1, wherein the SIB message comprises at least one of a SIB31 message, a SIB32 message, or a SIB19 message.

5. The method of claim 1, comprising:
transmitting a non-access stratum (NAS) signaling message to the UE,
wherein the NAS signaling message transmitted by the network apparatus to the UE comprises at least one of an attach accept message, an attach reject message, a tracking area update (TAU) accept message, a TAU reject message, a service accept message, a service reject message, a registration accept message, a registration reject message, an authentication result message, an authentication reject message, a detach accept message, a deregistration accept message, a UE configuration update command (UCU) message, a UE parameters update command (UPU) message, a UE capability enquiry message, packet data unit (PDU) session establishment accept, PDU session establishment reject, PDN Connectivity Accept, PDN Connectivity Reject, an existing NAS signaling message, or a new NAS signaling message.

6. The method of claim 1, wherein the SIB message comprises a plurality of parameters of the S&F mode.

7. The method of claim 6,
wherein the plurality of parameters of the S&F mode includes at least one of a S&F support capability, a S&F data storage quota, a S&F data retention period or a S&F data forwarding priority, and
wherein the plurality of parameters of the S&F mode is determined based on a satellite coverage availability information.

8. The method of claim 1, comprising:
determining, by the network apparatus, whether a feeder link is available or not; and
transmitting, by the network apparatus, a non-access stratum (NAS) signaling message to the UE,
wherein the NAS signaling message indicates that the S&F satellite operation is being applied in case that the feeder link is not available.

9. A method performed by a user equipment (UE) for handling a store and forward (S&F) satellite operation for satellite communication, the method comprising:
receiving, from a network apparatus, a system information block (SIB) message including information indicating that the network apparatus is operating in a S&F mode;
after receiving the SIB message, transmitting a UE capability message to the network apparatus, determining whether the UE supports an access to the network apparatus operating in the S&F mode;
in accordance with a determination that the UE supports the access to the network apparatus operating in the S&F mode, transmitting, to the network apparatus, the UE capability message including information indicating that the UE supports the access to the network apparatus operating in the S&F mode; and
performing a communication with the network apparatus based on the S&F mode.

10. The method of claim 9, further comprising:
transmitting, by the UE, a first NAS signaling message to the network apparatus in accordance with a determination that the UE is in the satellite coverage and supports the S&F mode; and
receiving, by the UE, a second NAS signaling message from the network apparatus in response to the first NAS signaling message.

11. The method of claim 10, comprising:
determining, by the UE, whether the UE has subscribed for a S&F capability by using UE subscription information for a S&F capability,
wherein the UE subscription information includes at least one of a S&F data storage quota of the UE, a S&F data retention period of the UE, a S&F data forwarding priority of the UE and a S&F support capability of the UE.

12. The method of claim 10, wherein the first NAS signaling message transmitted by the UE to the network apparatus comprises at least one of an Attach Request message, a tracking area update (TAU) Request message, a Service Request message, a Registration Request message, an Authentication Request message, a Detach Request message, a Deregistration Request message, an UE capability information message, packet data unit (PDU) Session establishment request, packet data network (PDN) Connectivity request, an existing NAS signaling message and a new NAS signaling message.

13. The method of claim 10, wherein the first NAS signaling message includes at least one of a S&F feature supported flag signaling an ability of the UE to handle S&F operations, an expected S&F data storage quota of the UE, a S&F data retention period and a S&F data forwarding priority.

14. A network apparatus for handling a store and forward (S&F) satellite operation for satellite communication, the network apparatus comprising:
at least one processor comprising processing circuitry; and
memory storing instructions that,
wherein the instructions, when executed by the at least one processor individually or collectively, cause the network apparatus to:
determine, by a network apparatus, whether the network apparatus is operating in a S&F mode or not;
transmit a system information block (SIB) message to a user equipment (UE), in accordance with a determination that the network apparatus is operating in the S&F mode, the SIB message including information indicating that the network apparatus is operating in the S&F mode;
receive a UE capability message from the UE, the UE capability message including information indicating whether the UE supports an access to the network apparatus operating in the S&F mode; and
based on the information indicates that the UE supports the access to the network apparatus operating in the S&F mode, perform a communication with the UE based on the S&F mode.

15. The network apparatus of claim 14, wherein the SIB message comprises a plurality of parameters of the S&F mode.

16. A user equipment (UE) for handling a store and forward (S&F) satellite operation for satellite communication, the UE comprising:
at least one processor comprising processing circuitry; and
memory storing instructions that,
wherein the instructions, when executed by the at least one processor individually or collectively, cause the UE to:
receive, from a network apparatus, a system information block (SIB) message including information indicating that the network apparatus is operating in a S&F mode;
after receiving the SIB message, transmitting a UE capability message to the network apparatus, determine whether the UE supports an access to the network apparatus operating in the S&F mode;
in accordance with a determination that the UE supports the access to the network apparatus operating in the S&F mode, transmit, to the network apparatus, the UE capability message including information indicating that the UE supports the access to the network apparatus operating in the S&F mode; and
perform a communication with the network apparatus based on the S&F mode.

17. The UE of claim 16, wherein the instructions, when executed by the one or more processors individually or collectively, further cause the UE to:
transmit a first NAS signaling message to the network apparatus in accordance with a determination that the UE is in the satellite coverage and supports the S&F mode, and
receive a second NAS signaling message from the network apparatus in response to the first NAS signaling message.

18. The UE of claim 16, wherein the SIB message comprises a plurality of parameters of the S&F mode.
